(19) United States
(12) Patent Application Publication
(10) Pub. No.: US 2021/0409176 A1
(43) Pub. Date: Dec. 30, 2021

(54) CHANNEL STATE INFORMATION REFERENCE SIGNAL PARAMETER LINKAGE

(71) Applicant: QUALCOMM Incorporated, San Diego, CA (US)

(72) Inventors: Iyab Issam SAKHNINI, San Diego, CA (US); Tao LUO, San Diego, CA (US); Wanshi CHEN, San Diego, CA (US); Juan MONTOJO, San Diego, CA (US); Jelena DAMNJANOVIC, Del Mar, CA (US); Peter GAAL, San Diego, CA (US); Mahmoud TAHERZADEH BOROUJENI, San Diego, CA (US); Junyi LI, Fairless Hills, PA (US)

(21) Appl. No.: 17/334,181

(22) Filed: May 28, 2021

Related U.S. Application Data
(60) Provisional application No. 63/044,776, filed on Jun. 26, 2020.
(60) Provisional application No. 63/044,796, filed on Jun. 26, 2020.

(51) Int. Cl. H04L 5/00; H04W 72/12; H04W 72/14

(52) U.S. Cl. CPC H04L 5/0048; H04W 72/14; H04W 72/1289

(57) ABSTRACT

Some techniques and apparatuses described herein enable a base station to configure a CSI-RS resource set with one or more parameters that are linked to one or more parameters of least one of a message that triggers CSI-RS monitoring, a physical channel associated with the CSI-RS monitoring, or an uplink reference signal associated with the CSI-RS monitoring. This allows the one or more parameters of the CSI-RS resource set to be dynamically set and/or adjusted based at least in part on the one or more parameters to which the one or more parameters of the CSI-RS resource set are linked. As a result, scheduling flexibility for beam management, downlink communications, and/or uplink communications may be increased. This may reduce delays and increase network speed, reliability, and/or beam management efficiency. Numerous other aspects are provided.

### CROSS-REFERENCE TO RELATED APPLICATIONS

This Patent application claims priority to U.S. Provisional Patent Application No. 63/044,776, filed on Jun. 26, 2020, entitled “CHANNEL STATE INFORMATION REFERENCE SIGNAL PARAMETER LINKAGE,” and assigned to the assignee hereof, and U.S. Provisional Patent Application No. 63/044,796, filed on Jun. 26, 2020, entitled “BEAM INDICATION USING CHANNEL STATE INFORMATION REFERENCE SIGNALS,” and assigned to the assignee hereof. The disclosures of the prior Applications are considered part of and are incorporated by reference into this Patent Application.

### FIELD OF THE DISCLOSURE

Aspects of the present disclosure generally relate to wireless communication and to techniques and apparatuses for channel state information reference signal (CSI-RS) parameter linkage.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” (or “forward link”) refers to the communication link from the BS to the UE, and “uplink” (or “reverse link”) refers to the communication link from the UE to the BS. As will be described in more detail herein, a BS may be referred to as a Node B, a gNB, an access point (AP), a radio head, a transmit receive point (TRP), a 5G BS, a 5G Node B, or the like.

The above multiple access technologies have been adopted in various telecommunication standards to provide a common protocol that enables different wireless communication devices to communicate on a municipal, national, regional, and even global level. 5G, which may also be referred to as New Radio (NR), is a set of enhancements to the LTE mobile standard promulgated by the 3GPP. 5G is designed to better support mobile broadband Internet access by improving spectral efficiency, lowering costs, improving services, making use of new spectrum, and better integrating with other open standards using OFDM with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LTE and 5G technologies. Preferably, these improvements should be applicable to other multiple access technologies and the telecommunication standards that employ these technologies.

### SUMMARY

Aperiodic channel state information reference signals (CSI-RSs) for beam management may be triggered dynamically using downlink control information (DCI). However, the configuration for CSI-RS resources used to transmit the CSI-RSs is semi-static. Accordingly, although an aperiodic CSI-RS may be triggered dynamically, the CSI-RS is transmitted using CSI-RS resources with pre-configured parameters, such as an aperiodic triggering offset, bandwidth, and/or quasi co-location (QCL) relationship. This may limit scheduling flexibility for beam management, downlink communications, and/or uplink communications, which may result in delays, reduced network speed and/or reliability, and/or inefficient beam management.

Some techniques and apparatuses described herein enable a base station to configure a CSI-RS resource set with one or more parameters that are linked to one or more parameters of least one of a message that triggers CSI-RS monitoring, a physical channel associated with the CSI-RS monitoring, or an uplink reference signal associated with the CSI-RS monitoring. This allows the one or more parameters of the CSI-RS resource set to be dynamically set and/or adjusted based at least in part on the one or more parameters to which the one or more parameters of the CSI-RS resource set are linked. As a result, scheduling flexibility for beam management, downlink communications, and/or uplink communications may be increased. This may reduce delays and increase network speed, reliability, and/or beam management efficiency.

In some aspects, a method of wireless communication performed by a UE includes: receiving a configuration that indicates a CSI-RS resource set, wherein a first set of parameters of the CSI-RS resource set depends on a second set of parameters of at least one of a message that triggers CSI-RS monitoring for the CSI-RS resource set, a physical channel associated with the CSI-RS monitoring, or an uplink reference signal associated with the CSI-RS monitoring; and monitoring for one or more CSI-RSs, included in the CSI-RS resource set, based at least in part on the first set of parameters.

In some aspects, a method of wireless communication performed by a base station includes: transmitting, to a UE, a configuration that indicates a CSI-RS resource set, wherein a first set of parameters of the CSI-RS resource set depends on a second set of parameters of at least one of a message that triggers CSI-RS monitoring for the CSI-RS resource set, a physical channel associated with the CSI-RS monitoring, or an uplink reference signal associated with the CSI-RS monitoring; and transmitting one or more CSI-RSs, included in the CSI-RS resource set, based at least in part on the first set of parameters.

In some aspects, a UE for wireless communication includes: a memory; and one or more processors operatively coupled to the memory, the memory and the one or more processors configured to: receive a CSI-RS resource set, wherein a first set of parameters of the CSI-RS resource set depends on a second set of parameters of at least one of a message that triggers CSI-RS monitoring for the CSI-RS resource set, a physical channel associated with the CSI-RS monitoring, or an uplink reference signal associated with the CSI-RS monitoring; and monitor for one or more CSI-RSs, included in the CSI-RS resource set, based at least in part on the first set of parameters.

In some aspects, a base station for wireless communication includes: a memory; and one or more processors operatively coupled to the memory, the memory and the one or more processors configured to: transmit, to a UE, a configuration that indicates a CSI-RS resource set, wherein a first set of parameters of the CSI-RS resource set depends on a second set of parameters of at least one of a message that triggers CSI-RS monitoring for the CSI-RS resource set, a physical channel associated with the CSI-RS monitoring, or an uplink reference signal associated with the CSI-RS monitoring; and transmit one or more CSI-RSs, included in the CSI-RS resource set, based at least in part on the first set of parameters.

In some aspects, a non-transitory computer-readable medium storing a set of instructions for wireless communication includes: one or more instructions that, when executed by one or more processors of a UE, cause the UE to: receive a configuration that indicates a CSI-RS resource set, wherein a first set of parameters of the CSI-RS resource set depends on a second set of parameters of at least one of a message that triggers CSI-RS monitoring for the CSI-RS resource set, a physical channel associated with the CSI-RS monitoring, or an uplink reference signal associated with the CSI-RS monitoring; and monitor for one or more CSI-RSs, included in the CSI-RS resource set, based at least in part on the first set of parameters.

In some aspects, a non-transitory computer-readable medium storing a set of instructions for wireless communication includes: one or more instructions that, when executed by one or more processors of a base station, cause the base station to: transmit, to a UE, a configuration that indicates a CSI-RS resource set, wherein a first set of parameters of the CSI-RS resource set depends on a second set of parameters of at least one of a message that triggers CSI-RS monitoring for the CSI-RS resource set, a physical channel associated with the CSI-RS monitoring, or an uplink reference signal associated with the CSI-RS monitoring; and transmit one or more CSI-RSs, included in the CSI-RS resource set, based at least in part on the first set of parameters.

In some aspects, an apparatus for wireless communication includes: means for receiving a configuration that indicates a CSI-RS resource set, wherein a first set of parameters of the CSI-RS resource set depends on a second set of parameters of at least one of a message that triggers CSI-RS monitoring for the CSI-RS resource set, a physical channel associated with the CSI-RS monitoring, or an uplink reference signal associated with the CSI-RS monitoring; and means for monitoring for one or more CSI-RSs, included in the CSI-RS resource set, based at least in part on the first set of parameters.

In some aspects, an apparatus for wireless communication includes: means for transmitting, to a UE, a configuration that indicates a CSI-RS resource set, wherein a first set of parameters of the CSI-RS resource set depends on a second set of parameters of at least one of a message that triggers CSI-RS monitoring for the CSI-RS resource set, a physical channel associated with the CSI-RS monitoring, or an uplink reference signal associated with the CSI-RS monitoring; and means for transmitting one or more CSI-RSs, included in the CSI-RS resource set, based at least in part on the first set of parameters.

Aspects generally include a method, apparatus, system, computer program product, non-transitory computer-readable medium, user equipment, base station, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

FIG. 1 is diagram illustrating an example of a wireless network.

FIG. 2 is a diagram illustrating an example of a base station in communication with a user equipment (UE) in a wireless network.

FIG. 3 is a diagram illustrating examples of channel state information reference signal (CSI-RS) beam management procedures.

FIGS. 4-6 are diagrams illustrating examples associated with CSI-RS parameter linkage.

FIG. 7 is a diagram illustrating an example of using beams for communications between a base station and a UE.

FIGS. 8-9 are diagrams illustrating examples associated with beam indication using CSI-RSs.

FIGS. 10-13 are flowcharts of example methods of wireless communication.

FIG. 14 is a block diagram of an example apparatus for wireless communication.

FIG. 15 is a diagram illustrating an example of a hardware implementation for an apparatus employing a processing system.

FIG. 16 is a block diagram of an example apparatus for wireless communication.

FIG. 17 is a diagram illustrating an example of a hardware implementation for an apparatus employing a processing system.

### DETAILED DESCRIPTION

The detailed description set forth below in connection with the appended drawings is intended as a description of various configurations and is not intended to represent the configurations in which the concepts described herein may be practiced. The detailed description includes specific details for the purposes of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, or the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, or the like, whether referred to as software, firmware, middleware, microcode, hardware description language, or otherwise.

Accordingly, in one or more example embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), compact disk ROM (CD-ROM) or other optical disk storage, magnetic disk storage or other magnetic storage devices, combinations of the aforementioned types of computer-readable media, or any other medium that can be used to store computer executable code in the form of instructions or data structures that can be accessed by a computer.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

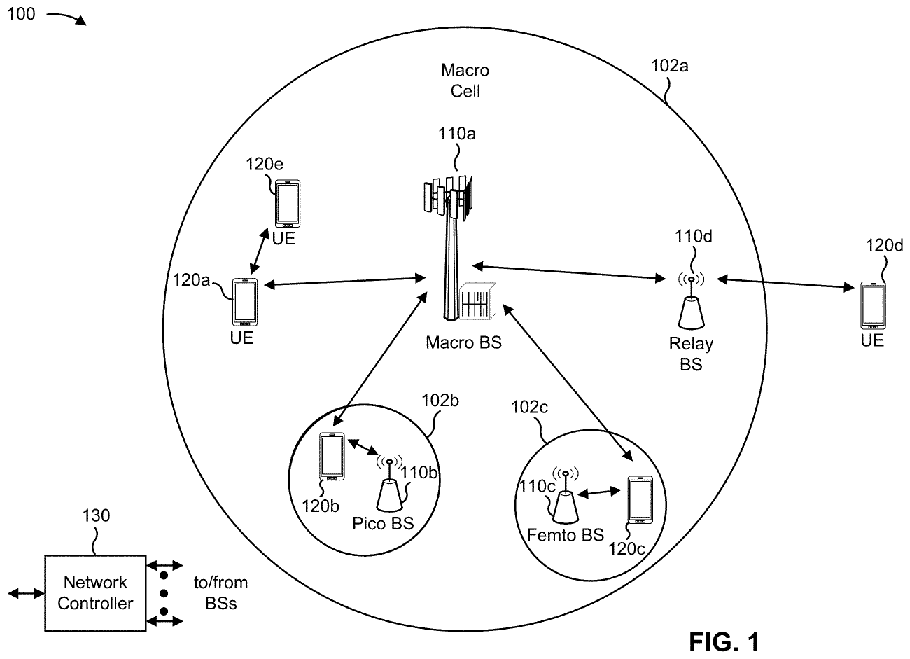

FIG. 1 is a diagram illustrating a wireless network 100 in which aspects of the present disclosure may be practiced. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as a 5G BS, a Node B, a gNB, a 5G NB, an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

ABS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. ABS may support one or multiple (e.g., three) cells. The terms “eNB”, “base station”, “5G BS”, “gNB”, “TRP”, “AP”, “node B”, “5G NB”, and “cell” may be used interchangeably herein.

In some examples, a cell may not necessarily be stationary, and the geographic area of the cell may move according to the location of a mobile BS. In some examples, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, etc. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, etc., that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components, memory components, or the like.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

In some aspects, a base station 110 may serve different UEs 120 of different categories, different UEs 120 that support different capabilities. For example, the base station 110 may serve a UE 120f that has a less advanced capability (e.g., a lower capability, a reduced capability, or the like) and/or a UE 120g that has a more advanced capability (e. g, a higher capability). For example, the UE 120f may be a first category of UE 120 (e.g., an NR-Lite UE, a low tier UE, a reduced capability UE, or the like), and the UE 120g may be a second category of UE 120 (e.g., an NR UE, a high tier UE, a premium UE, a legacy UE, or the like). Additionally, or alternatively, the UE 120f may have a reduced feature set compared to the UE 120g. In some aspects, the UE 120f may include an MTC UE, an eMTC UE, and/or an IoT UE, among other examples, as described above.

As indicated above, FIG. 1 is provided as an example. Other examples may differ from what is described with regard to FIG. 1.

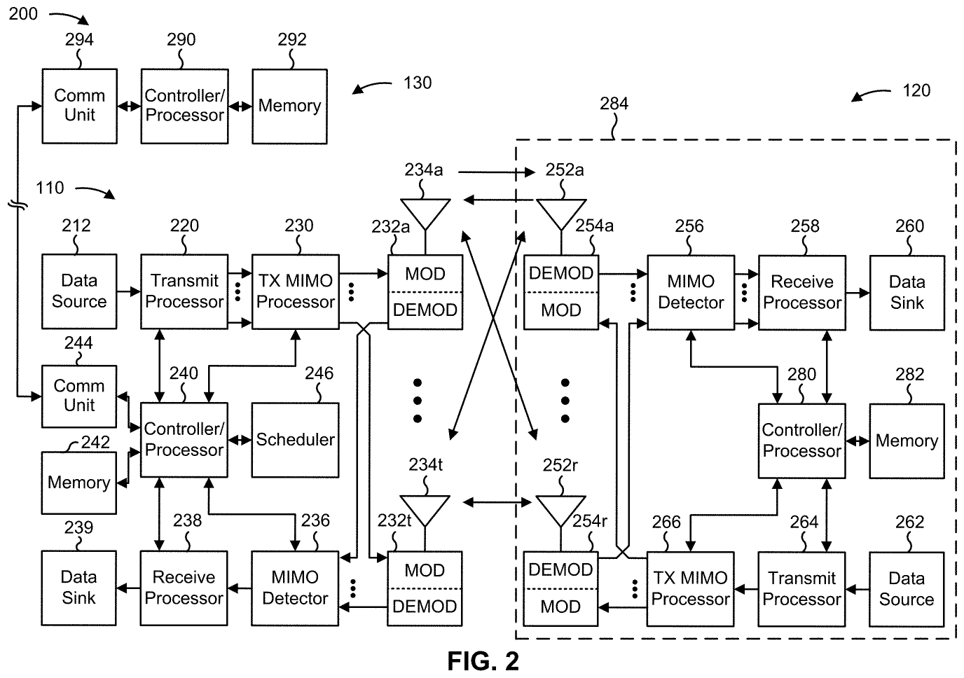

FIG. 2 is a diagram illustrating an example 200 of a base station 110 in communication with a UE 120 in a wireless network 100. Base station 110 may be equipped with T antennas 234a through 234t, and UE 120 may be equipped with R antennas 252a through 252r, where in general T>1 and R>1.

At base station 110, a transmit processor 220 may receive data from a data source 212 for one or more UEs, may select a modulation and coding scheme (MCS) for each UE based at least in part on channel quality indicators (CQIs) received from the UE, process (e.g., encode and modulate) the data for each UE based at least in part on the MCS selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS), a phase tracking reference signal (PTRS), and/or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for orthogonal frequency division multiplexing (OFDM)) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive (RX) processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein. A scheduler 246 may schedule UEs for data transmission on the downlink and/or uplink.

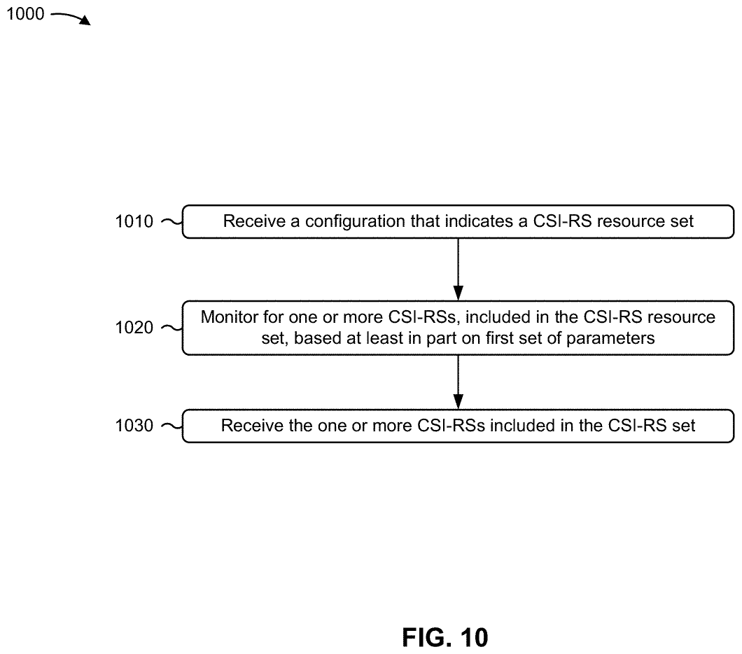

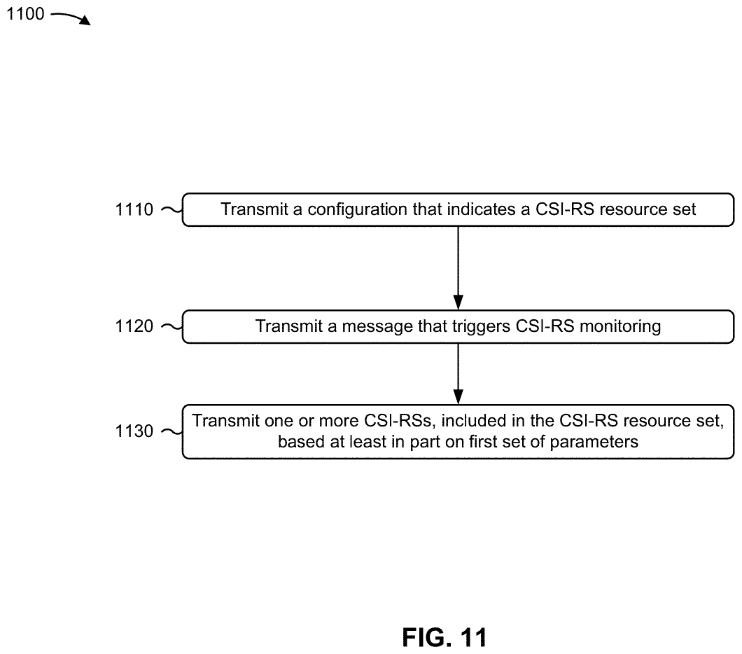

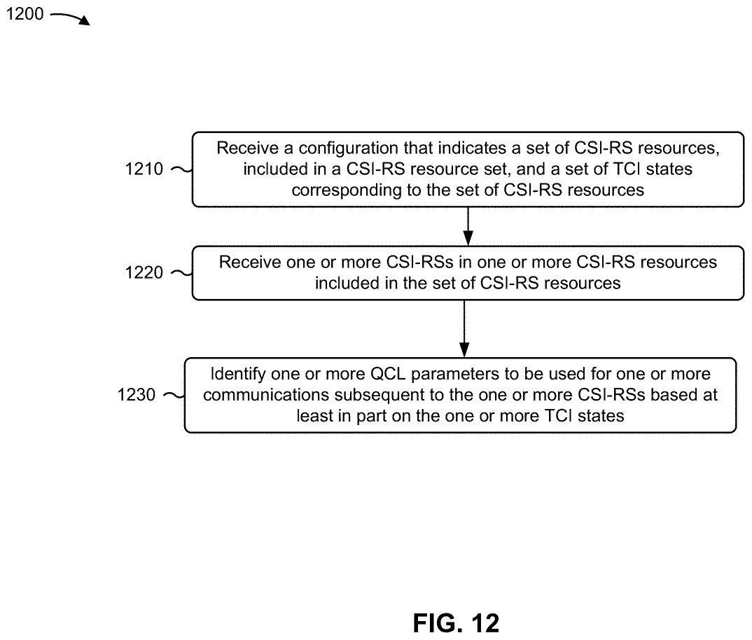

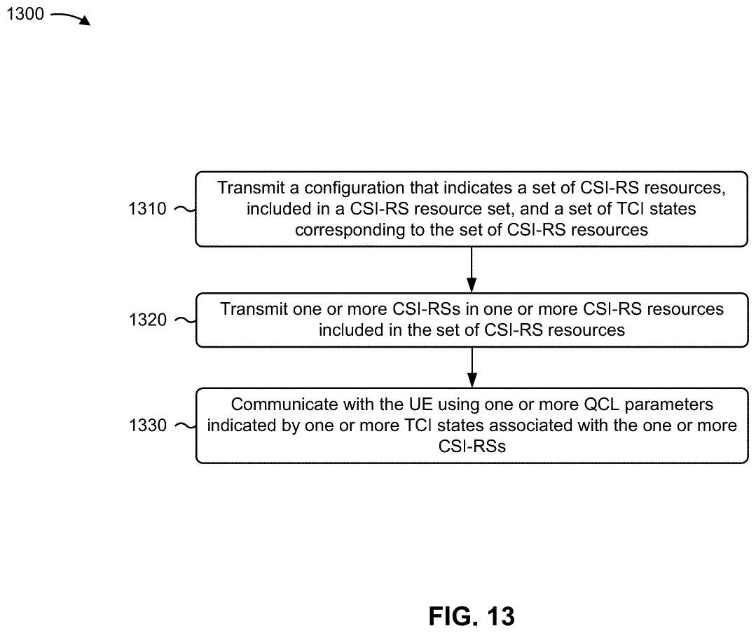

Controller/processor 240 of base station 110, controller/processor 280 of UE 120, and/or any other component(s) of FIG. 2 may perform one or more techniques associated with channel state information reference signal (CSI-RS) parameter linking, as described in more detail elsewhere herein. For example, controller/processor 240 of base station 110, controller/processor 280 of UE 120, and/or any other component(s) of FIG. 2 may perform or direct operations of, for example, method 1000 of FIG. 10, method 1100 of FIG. 11, method 1200 of FIG. 12, method 1300 of FIG. 13, and/or other processes as described herein. Memories 242 and 282 may store data and program codes for BS 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, method 1000 of FIG. 10, method 1100 of FIG. 11, method 1200 of FIG. 12, method 1300 of FIG. 13, and/or other processes as described herein. In some aspects, executing instructions may include running the instructions, converting the instructions, compiling the instructions, and/or interpreting the instructions, among other examples.

As indicated above, FIG. 2 is provided as an example. Other examples may differ from what is described with regard to FIG. 2.

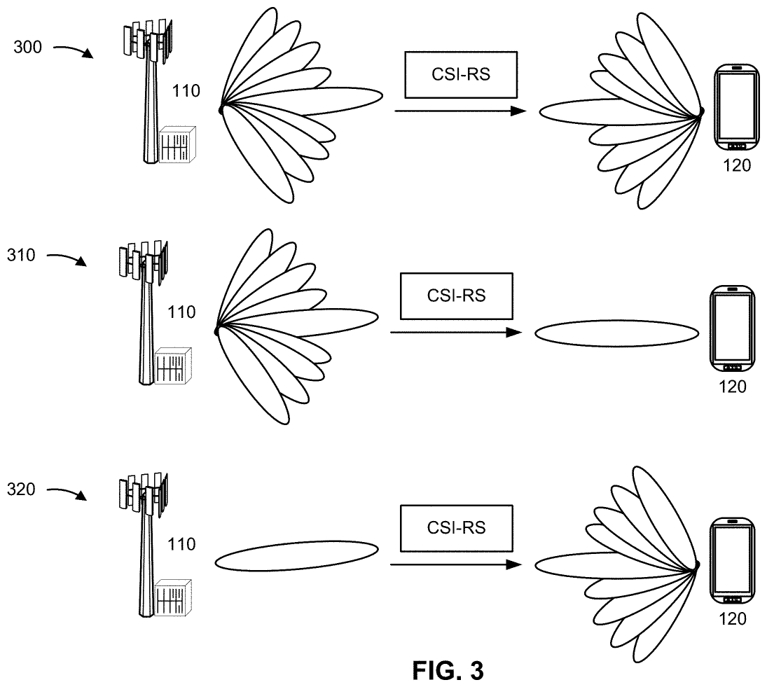

FIG. 3 is a diagram illustrating examples 300, 310, and 320 of CSI-RS beam management procedures. As shown in FIG. 3, examples 300, 310, and 320 include a UE 120 in communication with a base station 110 in a wireless network (e.g., wireless network 100). However, the devices shown in FIG. 3 are provided as examples, and the wireless network may support communication and beam management between other devices (e.g., between a UE 120 and a base station 110 or TRP, between a mobile termination node and a control node, between an integrated access and backhaul (IAB) child node and an IAB parent node, and/or between a scheduled node and a scheduling node). In some aspects, the UE 120 and the base station 110 may be in a connected state (e.g., a radio resource control (RRC) connected state).

As shown in FIG. 3, example 300 may include a base station 110 and a UE 120 communicating to perform beam management using CSI-RSs. Example 300 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 3 and example 300, CSI-RSs may be configured to be transmitted from the base station 110 to the UE 120. The CSI-RSs may be configured to be periodic (e.g., using RRC signaling), semi-persistent (e.g., using medium access control (MAC) control element (MAC-CE) signaling), and/or aperiodic (e.g., using downlink control information (DCI)).

The first beam management procedure may include the base station 110 performing beam sweeping over multiple transmit (Tx) beams. The base station 110 may transmit a CSI-RS using each transmit beam for beam management. To enable the UE 120 to perform receive (Rx) beam sweeping, each CSI-RS on a transmit beam can be transmitted repeatedly multiple times in the same CSI-RS resource set so that the UE 120 can sweep through receive beams in multiple transmission instants. For example, if the base station 110 has a set of N transmit beams and the UE 120 has a set of M receive beams, the CSI-RS may be transmitted on each of the N transmit beams M times so that the UE 120 may receive M beams per transmit beam. In other words, for each transmit beam of the base station 110, the UE 120 may perform beam sweeping through the receive beams of the UE 120. As a result, the first beam management procedure may enable the UE 120 to measure a CSI-RS on different transmit beams using different receive beams to support selection of base station 110 transmit beams/UE 120 receive beam(s) beam pair(s). The UE 120 may report the measurements to the base station 110 to enable the base station 110 to select one or more beam pair(s) for communication between the base station 110 and the UE 120. While example 300 has been described in connection with CSI-RSs, the first beam management process may also use synchronization signal blocks (SSBs) for beam management in a similar manner as described above.

As shown in FIG. 3, example 310 may include a base station 110 and a UE 120 communicating to perform beam management using CSI-RSs. Example 310 depicts a second beam management procedure (e.g., P2 CSI-RS beam management). The second beam management procedure may be referred to as a beam refinement procedure, a base station beam refinement procedure, a TRP beam refinement procedure, and/or a transmit beam refinement procedure. As shown in FIG. 3 and example 310, CSI-RSs may be configured to be transmitted from the base station 110 to the UE 120. The CSI-RSs may be configured to be aperiodic (e.g., using DCI). The second beam management procedure may include the base station 110 performing beam sweeping over one or more transmit beams. The one or more transmit beams may be a subset of all transmit beams associated with the base station 110 (e.g., determined based at least in part on measurements reported by the UE 120 in connection with the first beam management procedure). The base station 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the in connection with the first beam management procedure). The second beam management procedure may enable the base station 110 to select a best transmit beam based at least in part on reported measurements received from the UE 120 (e.g., using the single receive beam).

As shown in FIG. 3, example 320 may depict a third beam management procedure (e.g., P3 CSI-RS beam management). The third beam management procedure may be referred to as a beam refinement procedure, a UE beam refinement procedure, a and/or receive beam refinement procedure. As shown in FIG. 3 and example 320, one or more CSI-RSs may be configured to be transmitted from the base station 110 to the UE 120. The CSI-RSs may be configured to be aperiodic (e.g., using DCI). The third beam management process may include the base station 110 transmitting the one or more CSI-RSs on a single transmit beam (e.g., determined based at least in part on measurements reported by the UE 120 in connection with the first beam management procedure and/or the second beam management procedure). To enable the UE 120 to perform receive beam sweeping, the CSI-RS on the transmit beam can be transmitted repeatedly multiple times in the same CSI-RS resource set so that the UE 120 can sweep through one or more receive beams in multiple transmission instants. The one or more receive beams may be a subset of all receive beams associated with the UE 120 (e.g., determined based at least in part on measurements performed in connection with the first beam management procedure and/or the second beam management procedure). The third beam management procedure may enable the base station 110 and/or the UE 120 to select a best receive beam based at least in part on reported measurements received from the UE 120 (e.g., of the CSI-RS on the transmit beam using the one or more receive beams).

As indicated above, FIG. 3 is provided as an example. Other examples may differ from what is described with respect to FIG. 3.

A UE may measure a CSI-RS to determine channel state information (CSI), which may include a CQI, a precoding matrix indicator (PMI), a CSI-RS resource indicator (CRI), a layer indicator (LI), a rank indicator (RI), a layer 1 (L1) signal to interference plus noise ratio (L1-SINR), and/or an L1 reference signal received power (L1-RSRP) value. The UE may be configured with one or more CSI resource settings that are used to configure a list of one or more CSI resource sets. The list of CSI resource sets may include one or more non-zero-power (NZP) CSI-RS resource sets, one or more SSB sets, and/or one or more CSI interference measurement (CSI-IM) resource sets. The CSI resource settings may configure the time domain behavior of the CSI-RS resources to be aperiodic, periodic, or semi-persistent. Aperiodic and semi-persistent state triggering of the CSI-RS resources may be configured in RRC and triggered in DCI. The CSI resource settings may include a trigger state list that configures aperiodic or semi-persistent state triggering of the CSI-RS resources. For aperiodic CSI-RS, a number of slots between the triggering DCI and a slot containing the CSI-RS is semi-statically configured (e.g., using RRC) using an aperiodic triggering offset parameter. Bandwidth parameters and quasi co-location (QCL) relationships for the CSI-RS resources may also be semi-statically configured.

A base station and a UE may use CSI-RSs to perform downlink beam management. For base station transmit beam refinement, the base station may configure multiple CSI-RS resources (each sent from different base station transmit beams), the UE may measure CSI-RSs and report L1 measurements, and the base station may use the report of L1 measurements to select a base station transmit beam. For UE receive beam refinement, the base station may configure multiple repeated CSI-RS resources (sent using the same base station transmit beam), and the UE may sweep the UE receive beams to measure the CSI-RSs transmitted in the repeated CSI-RS resources and select a UE receive beam using the measurements.

Aperiodic CSI-RSs for beam management may be triggered dynamically using DCI. However, the configuration for the CSI-RS resources is semi-static. Accordingly, although an aperiodic CSI-RS may be triggered dynamically, the CSI-RS is transmitted using CSI-RS resources with pre-configured parameters, such as aperiodic triggering offset, bandwidth, and/or QCL. This may limit scheduling flexibility for beam management, downlink communications, and/or uplink communications. For example, scheduling flexibility for dynamic physical downlink shared channel (PDSCH) (e.g., UE receive beam refinement) before a PDSCH communication may be limited because the aperiodic triggering offset of the CSI-RS resource set used for the PDSCH beam training is semi-static and the PDSCH time domain resource allocation (TDRA) is dynamic. Since the aperiodic triggering offset is semi-static, in order for beam refinement to be performed for an upcoming PDSCH grant, the PDSCH TDRA needs to be greater than the aperiodic triggering offset. In addition, semi-static bandwidth and/or QCL parameters of CSI-RS resources may limit downlink scheduling flexibility, for example, in a situation in which there is heavy uplink traffic and available bandwidth is narrow. Thus, semi-static configuration of parameters for CSI-RS resources may limit scheduling flexibility for beam management, downlink communications, and/or uplink communications, which may result in delays, reduced network speed and/or reliability, and/or inefficient beam management.

Some techniques and apparatuses described herein enable a base station to configure a CSI-RS resource set with one or more parameters that are linked to one or more parameters of least one of a message that triggers CSI-RS monitoring, a physical channel associated with the CSI-RS monitoring, or an uplink reference signal associated with the CSI-RS monitoring. This allows the one or more parameters of the CSI-RS resource set to be dynamically set and/or adjusted based at least in part on the one or more parameters to which the one or more parameters of the CSI-RS resource set are linked. As a result, scheduling flexibility for beam management, downlink communications, and/or uplink communications may be increased. This may reduce delays and increase network speed, reliability, and/or beam management efficiency. Furthermore, by linking the one or more parameters of the CSI-RS set to one or more parameters of at least one of a message, channel, or signal associated with the CSI-RS monitoring, the one or more parameters of the CSI-RS resource set may be dynamically set and/or adjusted without increasing control signaling overheard and, thus, may conserve computing resources (e.g., processing resources, memory resources, and/or communication resources) and/or networking resources.

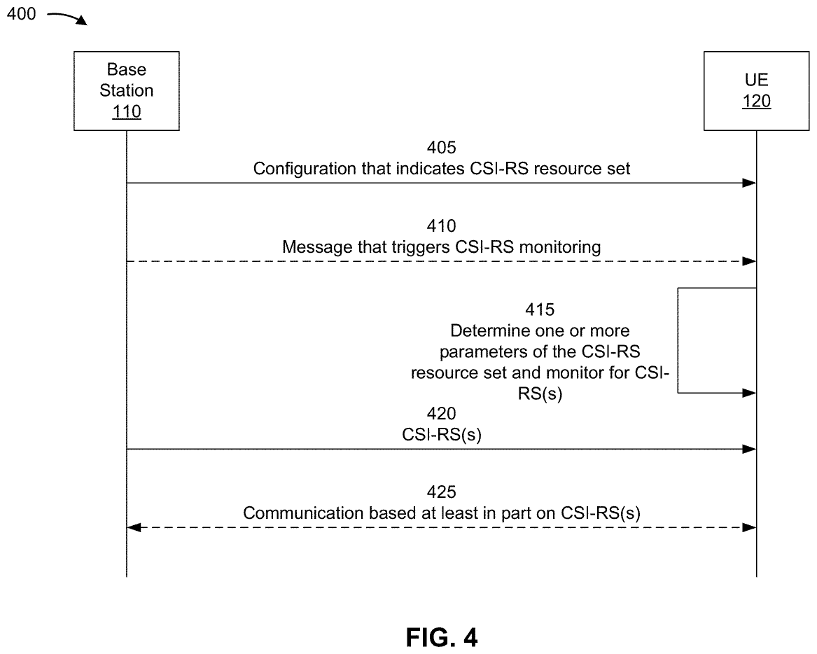

FIG. 4 is a diagram illustrating an example 400 associated with CSI-RS parameter linkage. As shown in FIG. 4, a base station 110 and a UE 120 may communicate with one another. In some aspects, the base station 110 and the UE 120 may be included in a wireless network such as wireless network 100. The base station 110 and the UE 120 may communicate on a wireless access link, which may include an uplink and a downlink.

At 405, the base station 110 may transmit, to the UE 120, a configuration that indicates a CSI-RS resource set. For example, the base station 110 may transmit, to the UE 120, configuration information (e.g., RRC information) that identifies one or more CSI-RS resources of the CSI-RS resource set. A first set of parameters of the CSI-RS resource set may depend on a second set of parameters of at least one of a message that triggers CSI-RS monitoring for the CSI-RS resource set, a physical channel associated with the CSI-RS monitoring, and/or an uplink reference signal associated with the CSI-RS monitoring.

The first set of parameters includes one or more parameters of the CSI-RS resource set. For example, the first set of parameters may include one or more of a timing offset for CSI-RS, a bandwidth, and/or a QCL relationship. The first set of parameters of the CSI-RS resource set may depend at least in part on the second set of parameters of at least one of a message that triggers CSI-RS monitoring for the CSI-RS resource set, a physical channel associated with the CSI-RS monitoring, and/or an uplink reference signal associated with the CSI-RS monitoring. A parameter in the first set of parameters may be linked with at least one parameter in the second set of parameters, such that a value for the parameter in the first set of parameters depends at least in part on a value of the at least one parameter in the second set of parameters. In some aspects, the configuration information may identify the linkage between the first set of parameters and the second set of parameters.

In some aspects, one or more parameters of the CSI-RS resource set may be linked with one or more parameters of a physical downlink channel, such as a PDSCH and/or a physical downlink control channel (PDCCH). In some aspects, one or more parameters of the CSI-RS resource set may be linked with one or more parameters of a physical uplink channel, such as a physical uplink shared channel (PUSCH) and/or a physical uplink control channel (PUCCH). In some aspects, one or more parameters of the CSI-RS resource set may be linked with one or more parameters of an uplink reference signal, such as sounding reference signal (SRS). In some aspects, one or more parameters of the CSI-RS resource set may be linked with one or more parameters of a message that triggers CSI-RS monitoring, such a DCI message and/or an MAC-CE.

The configuration information may be used to configure the CSI-RS resource set to be aperiodic, semi-persistent, and/or periodic. For an aperiodic CSI-RS resource set, the CSI-RS resource set may be configured such that CSI-RS transmission using the CSI-RS resource set by the base station 110 and CSI-RS monitoring by the UE 120 are aperiodically triggered by DCI that includes an uplink grant (e.g., on a PUSCH) and/or a downlink grant (e.g., on a PDSCH). Additionally, and/or alternatively, an aperiodic CSI-RS resource set may be configured such that CSI-RS transmission by the base station 110 and CSI-RS monitoring by the UE 120 are aperiodically triggered by a MAC-CE.

For a semi-persistent CSI-RS resource set, the configuration information may be used to configure a semi-persistent transmission (by the base station 110) and/or monitoring (by the UE 120) for the CSI-RS resource set. One or more parameters of a semi-persistent CSI-RS resource set may be, for example, linked with one or more parameters of a semi-persistent scheduling (SPS) PDSCH. For a periodic CSI-RS resource set, the configuration information may be used to configure a periodicity for a CSI-RS transmission (by the base station 110) and CSI-RS monitoring (by the UE 120). One or more parameters of a periodic CSI-RS resource set may be, for example, linked with one or more parameters of a periodic PDCCH.

As further shown in FIG. 4, at 410, the base station 110 may transmit, to the UE 120, a message that triggers CSI-RS monitoring for the CSI-RS resource set. For example, the message that triggers the CSI-RS monitoring may include DCI that triggers the CSI-RS monitoring by the UE 120. In some aspects, the DCI that triggers the CSI-RS monitoring may include an uplink grant (e.g., on a PUSCH) and/or a downlink grant (e.g., on a PDSCH). Additionally, and/or alternatively, the message that triggers the CSI-RS monitoring may include a MAC-CE to trigger the CSI-RS monitoring by the UE 120. In some aspects, the message that triggers the CSI-RS monitoring may be an aperiodic triggering message. In some aspects, the message that triggers CSI-RS monitoring may trigger semi-persistent CSI-RS monitoring.

In some aspects, the message that triggers the CSI-RS monitoring may identify a linkage between the first set of parameters of the CSI-RS resource set and the second set of parameters. In some aspects, the message that triggers the CSI-RS monitoring may include information used to override and/or modify a linkage between the first set of parameters of the CSI-RS resource set and the second set of parameters identified in the configuration information.

In some aspects, such as in a case in which the CSI-RS resource set is configured as a periodic CSI-RS resource set, the base station 110 may not transmit a message that triggers CSI-RS monitoring to the UE 120. In this case, the CSI-RS monitoring may be periodic with a periodicity set by the configuration.

As further shown in FIG. 4, at 415, the UE 120 determines one or more parameters of the CSI-RS resource set and monitors for one or more CSI-RSs based at least in part on the one or more parameters of the CSI-RS resource set. The determination of the one or more parameters of the CSI-RS resource set and the CSI-RS monitoring by the UE 120 may be in response to receiving the message that triggers the CSI-RS monitoring, or in response to a periodicity configured for a periodic CSI-RS resource set. The UE 120 may determine values for the first set of parameters of the CSI-RS resource set based at least in part on values for the second set of parameters using the linkage between the first set of parameters and the second set of parameters identified in the configuration and/or the message that triggers the CSI-monitoring. Values for the second set of parameters may be determined by the base station 110 and communicated to the UE 120, for example, in the message that triggers the CSI-RS monitoring, a message that schedules or grants an downlink or uplink communication (e.g., on a PDSCH, a PDCCH, a PUSCH, and/or a PUCCH). Additionally, and/or alternatively, values for the second set of parameters may be determined by the UE 120.

The first set of parameters of the CSI-RS resource set may include a bandwidth for the CSI-RS monitoring by the UE 120 (e.g., a bandwidth for CSI-RS transmission by the base station 110). In some aspects, the bandwidth for the CSI-RS monitoring may be determined based at least in part on a bandwidth for the message that triggers the CSI-RS monitoring for the CSI-RS resource set, a physical channel (e.g., PDSCH, PDCCH, PUSCH, and/or PUCCH) associated with the CSI-RS monitoring, or an uplink reference signal (e.g., SRS) associated with the CSI-RS monitoring. For example, bandwidth for the CSI-RS monitoring may be determined to be the same as or determined as a function of the bandwidth for the message that triggers the CSI-RS monitoring, the physical channel (e.g., PDSCH, PDCCH, PUSCH, and/or PUCCH), or the uplink reference signal (e.g., SRS).

The first set of parameters of the CSI-RS resource set may include a timing offset for the CSI-RS monitoring. In some aspects, the timing offset for the CSI-RS monitoring may be determined based at least in part on a timing of the message that triggers the CSI-RS monitoring for the CSI-RS resource set, a physical channel (e.g., PDSCH, PDCCH, PUSCH, and/or PUCCH) associated with the CSI-RS monitoring, or an uplink reference signal (e.g., SRS) associated with the CSI-RS monitoring.

The first set of parameters may include a QCL relationship for the CSI-RS monitoring. In some aspects, the QCL relationship for the CSI-RS monitoring is based at least in part on a QCL relationship of the message that triggers CSI-RS monitoring for the CSI-RS resource set, a physical channel (e.g., PDSCH, PDCCH, PUSCH, and/or PUCCH) associated with the CSI-RS monitoring, or an uplink reference signal (e.g., SRS) associated with the CSI-RS monitoring.

As further shown in FIG. 4, at 420, the base station 110 transmits one or more CSI-RSs in the CSI-RS resource set based at least in part on the first set of parameters. The base station 110 may determine values of the second set of parameters in order to dynamically set the values for the first set of parameters of the CSI-RS resource set that are linked with the second set of parameters. The base station 110 may determine the values of the second set of parameters to dynamically set the values for the first set of parameters in order to dynamically schedule beam refinement, downlink communications, and/or uplink communications by efficiently allocating time domain resources and/or bandwidth.

As further shown in FIG. 4, at 425, the base station 110 and the UE 120 communicate based at least in part on the one or more CSI-RSs transmitted in the CSI-RS resource set. For example, beam management (e.g., base station transmit beam refinement and/or UE receive beam refinement) may be performed by the base station 110 and/or the UE 120 using the one or more CSI-RSs transmitted in the CSI-RS resource set, and communications may be sent between the base station 110 and the UE 120 using the beams selected in the beam management. The communications may include downlink communications transmitted from the base station 110 to the UE 120 (e.g., on a PDSCH and/or a PDCCH), and/or uplink communications (e.g., on a PUSCH and/or a PUCCH) transmitted from the UE 120 to the base station 110. The uplink communications may include an uplink reference signal (e.g., SRS) transmitted from the UE 120 to the base station 110.

In some aspects, a time delay may be applied to allow for a switching delay between the reception of the one or more CSI-RSs by the UE 120 and transmission/reception of a subsequent communication, such as an uplink reference signal (e.g., SRS) and/or a communication on a physical channel (e.g., PDSCH, PDCCH, PUSCH, and/or PUCCH). For example, a timing between the one or more CSI-RSs and the subsequent communication may satisfy a switching delay threshold. In some aspects, the switching delay threshold may be indicated in the configuration and/or the message that triggers the CSI-RS monitoring. In some aspects, the switching delay threshold may be based at least in part on a capability of the UE 120. In some aspects, the switching delay threshold may be pre-configured and stored on the UE 120.

As described above in with FIG. 4, one or more parameters of the CSI-RS resource set may be linked to one or more parameters of least one of a message that triggers CSI-RS monitoring, a physical channel associated with the CSI-RS monitoring, or an uplink reference signal associated with the CSI-RS monitoring. This allows the one or more parameters of the CSI-RS resource set to be dynamically set and/or adjusted based at least in part on the one or more parameters to which the one or more parameters of the CSI-RS resource set are linked. As a result, scheduling flexibility for beam management, downlink communications, and/or uplink communications may be increased. This may reduce delays and increase network speed, reliability, and/or beam management efficiency.

As indicated above, FIG. 4 is provided as an example. Other examples may differ from what is described with respect to FIG. 4.

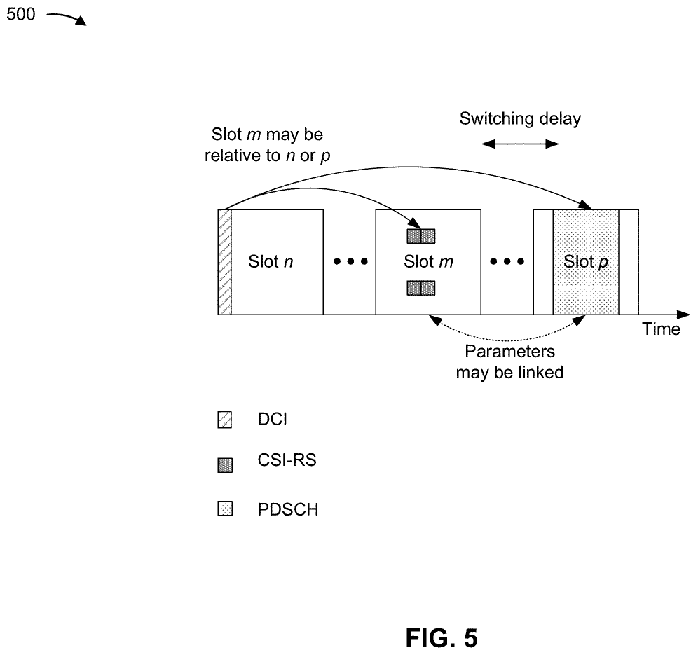

FIG. 5 is a diagram illustrating an example 500 associated with CSI-RS parameter linkage. Example 500 shows an example of CSI-RS parameter linkage for an aperiodic CSI-RS resource set.

As shown in FIG. 5, DCI may be transmitted from a base station (e.g., base station 110) to a UE (e.g., UE 120). The DCI may trigger a CSI-RS (e.g., triggers CSI-RS monitoring in the UE) and schedule a PDSCH for a downlink communication.

The CSI-RS is transmitted in a CSI-RS resource set, and one or more parameters of the CSI-RS resource set may be linked with one or more parameters of the DCI or the PDSCH. For example, a timing offset for the CSI-RS resource set that is used to determine a timing of the CSI-RS (slot m) may be determined based at least in part on the timing of the DCI (slot n) or may be determined based at least in part on the scheduled timing of the PDSCH (slot p). In addition, the bandwidth for the CSI-RS resource set may be determined based at least in part on the bandwidth of the DCI or the bandwidth of the PDSCH. A switching delay may be applied between the CSI-RS and the PDSCH, as described above.

As indicated above, FIG. 5 is provided as an example. Other examples may differ from what is described with respect to FIG. 5.

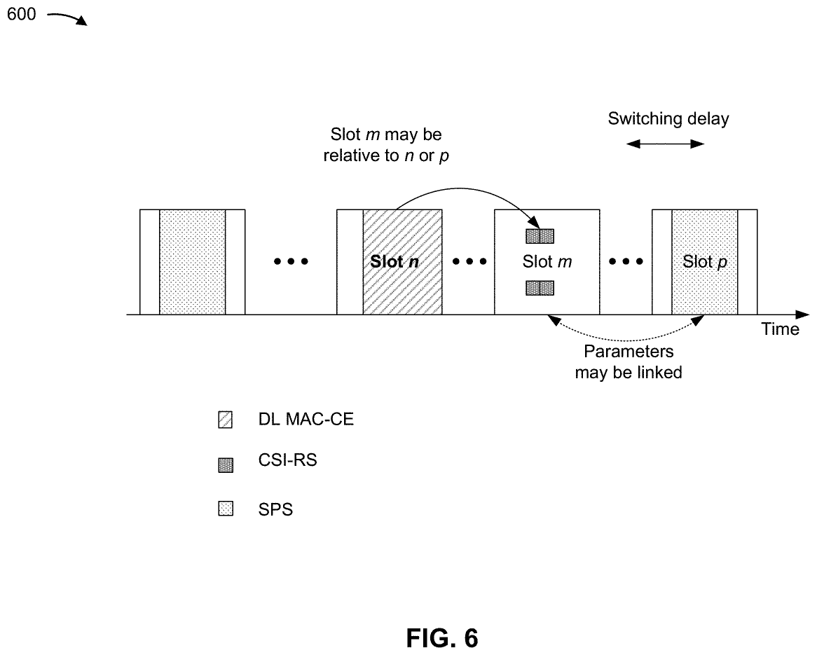

FIG. 6 is a diagram illustrating an example 600 associated with CSI-RS parameter linkage. Example 600 shows an example of CSI-RS parameter linkage for a semi-persistent CSI-RS resource set.

As shown in FIG. 6, a downlink MAC-CE may be transmitted from a base station (e.g., base station 110) to a UE (e.g., UE 120). The MAC-CE may trigger a CSI-RS prior to an SPS PDSCH for downlink communication.

The CSI-RS is transmitted in a CSI-RS resource set, and one or more parameters of the CSI-RS resource set may be linked with one or more parameters of the MAC-CE or the SPS PDSCH. For example, a timing offset for the CSI-RS resource set that is used to determine a timing of the CSI-RS (slot m) may be determined based at least in part on the timing of the MAC-CE (slot n) or may be determined based at least in part on the scheduled timing of the SPS PDSCH (slot p). In addition, the bandwidth for the CSI-RS resource set may be determined based at least in part on the bandwidth of the MAC-CE or the bandwidth of the SPS PDSCH. A switching delay may be applied between the CSI-RS and the SPS PDSCH, as explained above.

As indicated above, FIG. 6 is provided as an example. Other examples may differ from what is described with respect to FIG. 5.

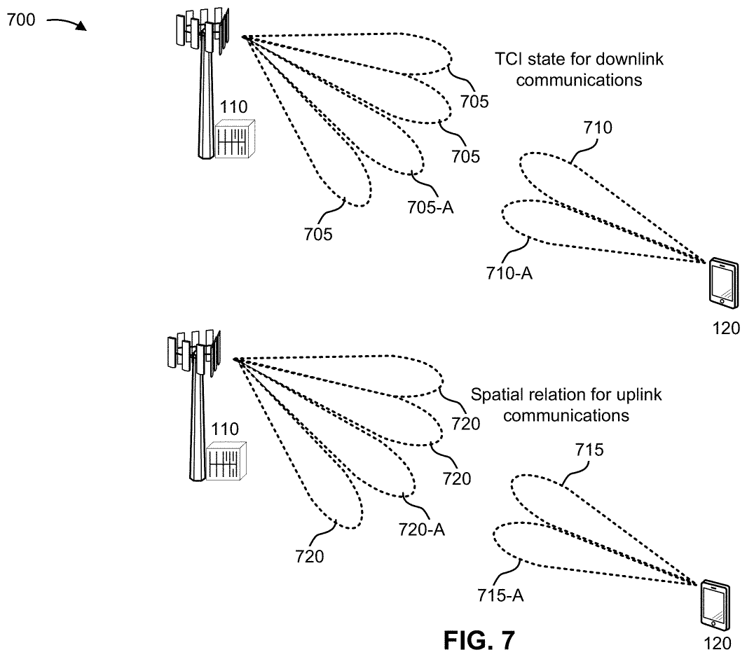

FIG. 7 is a diagram illustrating an example 700 of using beams for communications between a base station and a UE. As shown in FIG. 7, a base station 110 and a UE 120 may communicate with one another.

The base station 110 may transmit to UEs 120 located within a coverage area of the base station 110. The base station 110 and the UE 120 may be configured for beamformed communications, where the base station 110 may transmit in the direction of the UE 120 using a directional BS transmit beam, and the UE 120 may receive the transmission using a directional UE receive beam. Each BS transmit beam may have an associated beam ID, beam direction, or beam symbols, among other examples. The base station 110 may transmit downlink communications via one or more BS transmit beams 705.

The UE 120 may attempt to receive downlink transmissions via one or more UE receive beams 710, which may be configured using different beamforming parameters at receive circuitry of the UE 120. The UE 120 may identify a particular BS transmit beam 705, shown as BS transmit beam 705-A, and a particular UE receive beam 710, shown as UE receive beam 710-A, that provide relatively favorable performance (for example, that have a best channel quality of the different measured combinations of BS transmit beams 705 and UE receive beams 710). In some examples, the UE 120 may transmit an indication of which BS transmit beam 705 is identified by the UE 120 as a preferred BS transmit beam, which the base station 110 may select for transmissions to the UE 120. The UE 120 may thus attain and maintain a beam pair link (BPL) with the base station 110 for downlink communications (for example, a combination of the BS transmit beam 705-A and the UE receive beam 710-A), which may be further refined and maintained in accordance with one or more established beam refinement procedures.

A downlink beam, such as a BS transmit beam 705 or a UE receive beam 710, may be associated with a transmission configuration indication (TCI) state. A TCI state may indicate a directionality or a characteristic of the downlink beam, such as one or more QCL properties of the downlink beam. A QCL property may include, for example, a Doppler shift, a Doppler spread, an average delay, a delay spread, or spatial receive parameters, among other examples. In some examples, each BS transmit beam 705 may be associated with an SSB, and the UE 120 may indicate a preferred BS transmit beam 705 by transmitting uplink transmissions in resources of the SSB that are associated with the preferred BS transmit beam 705. A particular SSB may have an associated TCI state (for example, for an antenna port or for beamforming). The base station 110 may, in some examples, indicate a downlink BS transmit beam 705 based at least in part on antenna port QCL properties that may be indicated by the TCI state. A TCI state may be associated with one downlink reference signal set (for example, an SSB and an aperiodic, periodic, or semi-persistent CSI-RS) for different QCL types (for example, QCL types for different combinations of Doppler shift, Doppler spread, average delay, delay spread, or spatial receive parameters, among other examples). In cases where the QCL type indicates spatial receive parameters, the QCL type may correspond to analog receive beamforming parameters of a UE receive beam 710 at the UE 120. Thus, the UE 120 may select a corresponding UE receive beam 710 from a set of BPLs based at least in part on the base station 110 indicating a BS transmit beam 705 via a TCI indication.

The base station 110 may maintain a set of activated TCI states for downlink shared channel transmissions and a set of activated TCI states for downlink control channel transmissions. The set of activated TCI states for downlink shared channel transmissions may correspond to beams that the base station 110 uses for downlink transmission on a PDSCH. The set of activated TCI states for downlink control channel communications may correspond to beams that the base station 110 may use for downlink transmission on a PDCCH or in a control resource set (CORESET). The UE 120 may also maintain a set of activated TCI states for receiving the downlink shared channel transmissions and the CORESET transmissions. If a TCI state is activated for the UE 120, then the UE 120 may have one or more antenna configurations based at least in part on the TCI state, and the UE 120 may not need to reconfigure antennas or antenna weighting configurations. In some examples, the set of activated TCI states (for example, activated PDSCH TCI states and activated CORESET TCI states) for the UE 120 may be configured by a configuration message, such as an RRC message.

Similarly, for uplink communications, the UE 120 may transmit in the direction of the base station 110 using a directional UE transmit beam, and the base station 110 may receive the transmission using a directional BS receive beam. Each UE transmit beam may have an associated beam ID, beam direction, or beam symbols, among other examples. The UE 120 may transmit uplink communications via one or more UE transmit beams 715.

The base station 110 may receive uplink transmissions via one or more BS receive beams 720. The base station 110 may identify a particular UE transmit beam 715, shown as UE transmit beam 715-A, and a particular BS receive beam 720, shown as BS receive beam 720-A, that provide relatively favorable performance (for example, that have a best channel quality of the different measured combinations of UE transmit beams 715 and BS receive beams 720). In some examples, the base station 110 may transmit an indication of which UE transmit beam 715 is identified by the base station 110 as a preferred UE transmit beam, which the base station 110 may select for transmissions from the UE 120. The UE 120 and the base station 110 may thus attain and maintain a BPL for uplink communications (for example, a combination of the UE transmit beam 715-A and the BS receive beam 720-A), which may be further refined and maintained in accordance with one or more established beam refinement procedures. An uplink beam, such as a UE transmit beam 715 or a BS receive beam 720, may be associated with a spatial relation. A spatial relation may indicate a directionality or a characteristic of the uplink beam, similar to one or more QCL properties, as described above.

As indicated above, FIG. 7 is provided as an example. Other examples may differ from what is described with respect to FIG. 7.

A base station may serve different UEs of different categories, different UEs that support different capabilities. For example, the base station may serve a first category of UEs that have a less advanced capability (e.g., a low tier UE, a lower capability UE, a reduced capability UE, an NR-Lite UE, or the like) and a second category of UEs that have a more advanced capability (e.g., a higher capability UE, a high tier UE, a premium UE, an NR UE, a legacy UE, or the like). In this case, UEs of the first category may be non-stationary UEs (e.g., wearable devices) and/or stationary UEs (e.g., industrial wireless sensors, video surveillance cameras, or the like). For stationary UEs, a distribution of the UEs within the coverage of a base station may be such that certain beams are used to serve many more UEs than other beams, leading to overloading of those beams. In addition, stationary UEs may cause additional beam direction constraints at certain times. For example, other (e.g., non-stationary) UEs using different beam directions may experience delays due to beams being utilized for stationary UEs. These delays may particularly affect preconfigured messages, such as PDCCH communications, SPS communications, and/or configured grant (CG) communications.

To reduce beam overloading and blockage for UEs other than the stationary UEs, the base station may dynamically manage communications in time (e.g., by adding delays) and/or dynamically manage UE downlink assignments to allow beams to be free for the UEs other than the stationary UEs. However, this requires DCI and/or MAC-CE messages, which may introduce additional control signaling overhead. This may adversely affect network speed, and/or reliability, and unnecessarily consume computing resources (e.g., processing resources, memory resources, and/or communication resources) and/or networking resources.

Some techniques and apparatuses described herein enable a CSI-RS transmitted from a base station to a UE to act as an indication of a TCI state and corresponding QCL parameters for upcoming downlink and/or uplink communications. As a result, control signaling overhead associated with the base station dynamically managing communications and/or beam assignments may be reduced. This may increase network speed, and/or reliability, and conserve computing resources (e.g., processing resources, memory resources, and/or communication resources) and/or networking resources.

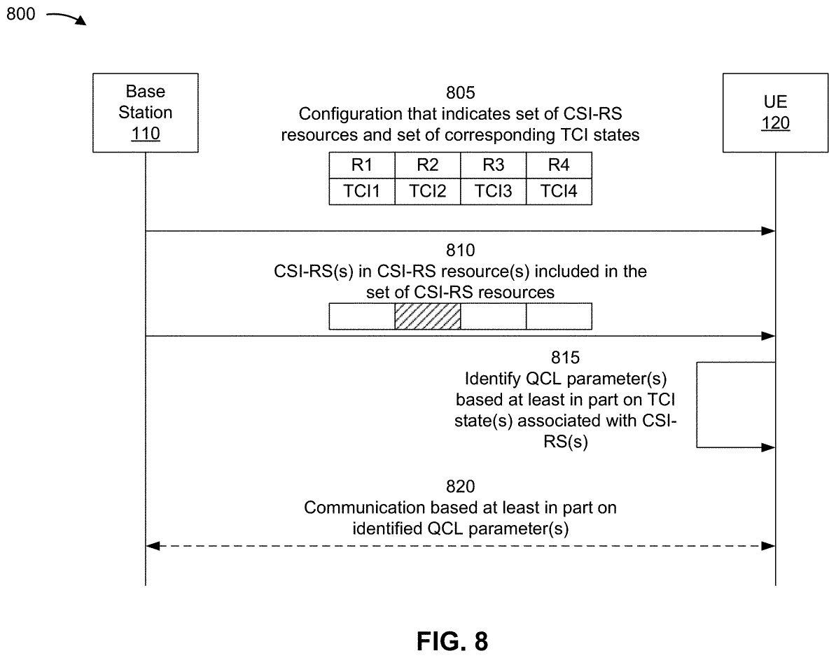

FIG. 8 is a diagram illustrating an example associated with beam indication using CSI-RSs. As shown in FIG. 8, a base station 110 and a UE 120 may communicate with one another. In some aspects, the base station 110 and the UE 120 may be included in a wireless network such as wireless network 100. The base station 110 and the UE 120 may communicate on a wireless access link, which may include an uplink and a downlink.

At 805, the base station 110 transmits, to the UE 120, a configuration that indicates a set of CSI-RS resources and a set of TCI states corresponding to the set of CSI-RS resources. For example, the base station 110 may transmit, to the UE 120, configuration information (e.g., RRC information and/or DCI) that identifies the set of CSI-RS resources and the set of corresponding TCI states. The set of CSI-RS resources may include N CSI-RS resources (e.g., time domain resources, frequency domain resources, spatial domain resources, and/or code domain resources) allocated for a periodic CSI-RS set. The configuration information may be used to configure a periodicity for transmission of the periodic CSI-RS set (or a subset of CSI-RSs in the periodic CSI-RS set) in the set of CSI-RS resources.

The configuration information may indicate a set of TCI states that correspond to the set of CSI-RS resources. A TCI state in the set of TCI states may indicate a directionality or a characteristic of a downlink beam, and may be associated with one or more QCL parameters. For example, a TCI state in the set of TCI states may be associated with one or more QCL parameters, such as a Doppler shift, a Doppler spread, an average delay, a delay spread, and/or a spatial receive parameter. In the example of FIG. 8, the configuration information may be used to configure a set of CSI-RS resources R1, R2, R3, and R4 and a corresponding set of TCI states TCI1, TCI2, TCI3, and TCI4. Each of the TCI states TCI1, TCI2, TCI3, and TCI4 may be associated with a respective one or more QCL parameters.

In some aspects, which CSI-RS resource (e.g., R1, R2, R3, or R4) is used for a CSI-RS transmission may be used to indicate, to the UE 120, a TCI state (e.g., TCI1, TCI2, TCI3, or TCI4) to be used for upcoming communications. The configuration information may be used to configure the UE 120 to determine a TCI state (e.g., TCI1, TCI2, TCI3, or TCI4) to be used for upcoming communications based at least in part on which CSI-RS resource (e.g., R1, R2, R3, or R4) resource is used for the CSI-RS transmission. For example, the UE 120 may be configured to detect a particular CSI-RS resource (e.g., R1, R2, R3, or R4) is used for a CSI-RS transmission (and/or detect the CSI-RS resources not used for the CSI-RS transmission), and to determine that the TCI state (e.g., TCI1, TCI2, TCI3, or TCI4) corresponding to that particular CSI-RS resource (e.g., R1, R2, R3, or R4) is to be used for upcoming communications.

In some aspects, the configuration information may identify a time window that controls how long to apply the TCI state indicated by a CSI-RS transmission. For example, the time window may be specified as a number of upcoming time domain resources (e.g., slots), a number of upcoming messages and/or a time period for which the indicated TCI state will be applied. In some aspects, certain combinations of two or more of the CSI-RS resources (e.g., R1, R2, R3, and/or R4) used for a CSI-RS transmission may be used to indicate the TCI state (e.g., TCI1, TCI2, TCI3, or TCI4) to be used for upcoming communications and the time window in which to apply that TCI state (e.g., TCI1, TCI2, TCI3, or TCI4).

In some aspects, the configuration information may identify messages/communications for which the TCI state indicated by a CSI-RS transmission is to be used. The configuration information may specify one or more specific types of messages, one or more specific channels, and/or one or more message configurations for which the indicated TCI state is to be used. For example, the configuration information may specify that the indicated TCI state is to be used for all PDSCHs, all CORESETs with a certain identifier and/or a certain SPS configuration. In some aspects, the configuration information may specify that the indicated TCI state is to be used for all types of messages, all channels, and all message configurations within a time window associated with the indicated TCI state.

As further shown in FIG. 8, at 810, the base station 110 may transmit, to the UE 120, one or more CSI-RSs in one or more CSI-RS resources included in the set of CSI-RS resources. The one or more CSI-RSs transmitted by the base station 110 are associated with one or more TCI states that are a subset of the set of TCI states corresponding to the set of CSI-RS resources. The one or more TCI states associated with the one or more CSI-RSs transmitted by the base station 110 provide an indication to the UE 120 of one or more QCL parameters to be used for one or more communications subsequent to the one or more CSI-RSs. The base station 110 may dynamically manage the QCL parameters for the subsequent communications by selecting one or more CSI-RSs to be transmitted that are associated with one or more TCI states corresponding to the QCL parameters to be used for the subsequent communications. The use of the CSI-RS(s) to provide an indication, to the UE 120, of the TCI state(s) and associated QCL parameters to be used for the subsequent communications reduces control signaling overhead associated with dynamically managing beam assignments for communications between the base station 110 and the UE 120. The base station 110 may transmit the one or more CSI-RSs at a transmission time associated with a periodic transmission configured for the set of CSI-RS resources.

In some aspects, the base station 110 may transmit a single CSI-RS in a single CSI-RS resource of the set of CSI-RS resources. In this case, the CSI-RS may be transmitted in the CSI-RS resource that corresponds to the TCI state associated with the CSI-RS. The base station 110 may transmit in the single CSI-RS resource without transmitting in the other CSI-RS resources of the set of CSI-RS resources. The use of the single CSI-RS resource for the transmission may provide an indication to the UE 120 that one or more QCL parameters associated with the TCI index corresponding to that single CSI-RS resource are to be used for one or more subsequent communications. As shown in the example of FIG. 8, the base station 110 may transmit a CSI-RS in a second resource (R2) of the configured set of CSI-RS resources. In this case, the CSI-RS transmitted in the second CSI-RS resource (R2) of the configured set of CSI-RS resources may be associated with the TCI state (TCI2) corresponding to the second CSI-RS resource (R2), and the use of only the second CSI-RS resource (R2) for the transmission may provide an indication to the UE 120 to use QCL parameters associated with the TCI state (TCI2) for one or more subsequent communications.

In some aspects, the base station 110 may transmit multiple CSI-RSs associated with multiple TCI states that are a subset of the TCI states corresponding to the set of CSI-RS resources. The CSI-RSs may be transmitted in the CSI-RS resources corresponding to the TCI states associated with the CSI-RSs. In some aspects, transmitting multiple CSI-RSs using certain combinations of the CSI-RS resources may be used to indicate to the UE 120 the TCI state and associated QCL parameters to be used for the subsequent communications and other information, such as a time window in which the QCL parameters are to be used. In some aspects, transmitting multiple CSI-RSs using multiple CSI-RS resources may be used to indicate to the UE 120 multiple TCI states to be used for subsequent communications that use multiple TCI states.

In some aspects, the base station 110 may transmit a CSI-RS associated with a TCI state in multiple CSI-RS resources of the set of CSI-RS resources. The base station 110 may transmit a CSI-RS associated with a single TCI state in multiple CSI-RS resources of the set of CSI-RS resources to provide an indication of QCL parameters corresponding to the TCI state associated with the CSI-RS and to support UE receive beam refinement by the UE 120. For example, to enable the UE 120 to perform receive beam sweeping, the CSI-RS may be repeatedly transmitted on a single transmit beam multiple times in the same CSI-RS resource set so that the UE 120 can sweep through one or more UE receive beams in multiple transmission instants. The TCI state associated with the CSI-RS may be a TCI state of the single transmit beam used to repeatedly transmitted the CSI-RS. The UE 120 may be configured to determine the TCI state associated with the CSI-RS (e.g., the TCI state of the single transmit beam used to transmit the CSI-RS) and/or determine which CSI-RS resource of the set of CSI-RS resources corresponds to the TCI state associated with the CSI-RS. Thus, the UE may identify an indicated TCI state and associated QCL parameters from the repeatedly transmitted CSI-RS.

As further shown in FIG. 8, at 815, the UE 120, in response to receiving the one or more CSI-RSs from the base station 110, may identify one or more QCL parameters to be used for one or more subsequent communications based at least in part on the one or more TCI states associated with the one or more CSI-RSs.

In some aspects, the UE 120 may identify the TCI state(s) associated with the CSI-RS(s) received from the base station 110 based at least in part on which CSI-RS resource(s) of the set of CSI-RS resources are used for the CSI-RS transmission (e.g., which CSI-RS resource(s) are used to transmit the CSI-RS(s)). For example, in a case in which the base station 110 transmits a single CSI-RS in a corresponding CSI-RS resource of the set of CSI-RS resources, the UE 120 may detect that a particular CSI-RS resource is being used (and/or detect that the other CSI-RS resources of the set of CSI-RS resources are not being used) and identify the TCI state that corresponds to that particular CSI-RS resource as a TCI state for one or more subsequent communications. The one or more QCL parameters to be used for the one or more subsequent communications may be one or more QCL parameters associated with the identified TCI state for the one or more subsequent communications.

The one or more subsequent communications may include downlink communications and/or uplink communications. For downlink communications (e.g., PDSCH communications, PDCCH (CORSET) communications, and/or SPS communications), one or more QCL parameters (e.g., Doppler shift, Doppler spread, average delay, delay spread, and/or spatial receive parameter) associated with the identified TCI state(s) may be used. For example, a TCI state of a subsequent downlink communication may be the same as the TCI state associated with the CSI-RS received from the base station 110. The one or more QCL parameters associated with the identified TCI state(s) may correspond to one or more beam(s) to be used for the subsequent downlink communications.

For uplink communications, the one or more QCL parameters associated with the identified TCI state may be one or more spatial relations for the one or more subsequent uplink communications. For example, the one or more spatial relations for the one or more subsequent uplink communications may be associated with the same spatial domain transmission filter or precoder as the identified TCI state(s) associated with the CSI-RS(s). In this case, a subsequent uplink communication may be transmitted using the same spatial domain transmission filter or precoder used for receiving the CSI-RS.

In some aspects, the identified QCL parameters may be applicable to communications in a time window that is based at least in part on a time domain resource in which the CSI-RS(s) is received. For example, the time window may be defined by a number of time domain resources (e.g., slots), a number of communications, and/or a time period subsequent to receiving the CSI-RS(s) from the base station 110. In some aspects, the time window may be signaled to the UE 120 in the configuration information (e.g., in an RRC communication), DCI, a MAC-CE, or a combination thereof. In some aspects, the time window may be indicated to the UE 120 based at least in part on the one or more CSI-RS resources in which the one or more CSI-RSs are received from the base station 110. For example, the use of certain combinations of the CSI-RS resources in the set of CSI-RS resources to transmit one or more CSI-RSs may indicate to the UE 120 the TCI state and associated QCL parameters to be used for subsequent communications and the time window in which the QCL parameters are to be used.

In some aspects, the identified QCL parameters may be applicable to one or more specific types of communications/messages, one or more specific channels, and/or one or more communication/message configurations. For example, the identified QCL resources may apply to all PDSCHs, all CORSETs with a certain identifier and/or a certain SPS configuration. In some aspects, the identified QCL parameters may apply to all types of messages, all channels, and all message configurations within the time window associated with the identified QCL parameters.

In some aspects, the identified one or more QCL parameters may be applicable to one or more communications that occur at least a threshold amount of time after reception of the CSI-RS(s). If the UE 120 determines that the identified one or more QCL parameters have changed in comparison with one or more current QCL parameters, the current QCL parameters may be applied for communications that occur less than the threshold amount of time after the CSI-RS(s) and the identified QCL parameters may be applied for communications that occur at least the threshold amount of time after the CSI-RS(s). The threshold amount of time may be based at least in part on a capability of the UE 120. For example, the threshold amount of time may be based at least in part on a time for the UE 120 to switch beams based at least in part on the identified QCL parameters. In some aspects, the threshold amount of time may be signaled to the UE 120. For example, the base station 110 may transmit, to the UE 120, information indicating the threshold amount of time using, for example, an RRC communication, DCI, and/or a MAC-CE.

In some aspects, the one or more subsequent communications may include multiple communications (e.g., two PDSCHs) that use multiple TCI states. The multiple TCI states (and associated QCL parameters) for the communications may be determined based at least in part on the one or more CSI-RSs received from the base station 110. The multiple TCI states may be determined by applying one or more rules. The one or more rules may be specified in the configuration information (e.g., in an RRC communication) or signaled to the UE 120 in another signaling communication (e.g., DCI and/or MAC-CE). For example, a rule may indicate that that the multiple TCI states follow an order of detected CSI-RS resources in which the CSI-RSs are received from the base station 110. In this case, a TCI state associated with a CSI-RS transmitted in a first detected CSI-RS resource may be used for a first TCI state associated with one or more first communications (e.g., on a first PDSCH) and a TCI state associated with a CSI-RS transmitted in a second detected CSI-RS resource may be used for a second TCI state associated with one or more second communications (e.g., on a second PDSCH).

In some aspects, the one or more CSI-RSs received from the base station 110 may include a repetition of a CSI-RS associated with a TCI state in multiple CSI-RS resources of the set of CSI-RS resources. In response, the UE 120 may identify the corresponding QCL parameters to be used for one or more subsequent communications based at least in part on the TCI state associated with CSI-RS and may perform beam refinement to refine a receive beam of the UE 120 based at least in part on the repeated CSI-RS in the CSI-RS resources. For example, to enable the UE 120 to perform receive beam sweeping, the CSI-RS may be repeatedly transmitted on a single transmit beam multiple times in the same CSI-RS resource set so that the UE 120 can sweep through one or more UE receive beams in multiple transmission instants. The TCI state associated with the CSI-RS may be a TCI state of the single transmit beam used to repeatedly transmit the CSI-RS. The UE 120 may be configured to determine the TCI state associated with the CSI-RS (e.g., the TCI state of the single transmit beam used to transmit the CSI-RS) and/or determine which CSI-RS resource of the set of CSI-RS resources corresponds to the TCI state associated with the CSI-RS. Thus, the UE may identify an indicated TCI state and associated QCL parameters from the repeatedly transmitted CSI-RS. In some aspects, the beam refinement may adjust the identified QCL parameters to be used for subsequent downlink communications.

As further shown in FIG. 8, at 820, the base station 110 and the UE 120 may communicate based at least in part on the identified one or more QCL parameters. For example, one or more communications between the base station 110 and the UE 120 that are subsequent to the CSI-RS may be transmitted and/or received on one or more beams based at least in part on the identified one or more QCL parameters. In some aspects, the identified QCL parameters may be used for communications between the base station 110 and the UE 120 within a time window subsequent to reception of the CSI-RS by the UE 120. In some aspects, the identified QCL parameters may be applicable to one or more specific types of communications, one or more specific channels, and/or one or more communication configurations. In some aspects, the identified one or more QCL parameters may be applicable to all types of communications, all channels, and/or all communication configurations.

In some aspects, the identified one or more QCL parameters may include one QCL parameters (e.g., Doppler shift, Doppler spread, average delay, delay spread, and/or spatial receive parameter) for downlink communications, and one or more downlink communications may be transmitted from the base station 110 and received at the UE 120 based at least in part on the identified one or more QCL parameters. For example, the identified one or more QCL parameters may be associated with a base station transmit beam on which the one or more downlink communications are transmitted from the base station 110 and/or a UE receive beam on which the one or more downlink communications are received by the UE 120.

In some aspects, the identified one or more QCL parameters may include one or more spatial relations for uplink communications, and one or more uplink communications may be transmitted from the UE 120 and received at the base station 110 based at least in part on the spatial relations. For example, the spatial relations may be associated with a UE 120 transmit beam on which the one or more uplink communications are transmitted from the UE 120 and/or a base station receive beam on which the one or more uplink communications are received by the base station 110.

As described above in connection with FIG. 8, a CSI-RS transmitted from the base station 110 to the UE 120 acts as an indication of a TCI state and corresponding QCL parameters for upcoming downlink and/or uplink communications. As a result, control signaling overhead associated with dynamically managing communications and/or beam assignments may be reduced. This may increase network speed and/or reliability and conserve computing resources (e.g., processing resources, memory resources, and/or communication resources) and/or networking resources.

As indicated above, FIG. 8 is provided as an example. Other examples may differ from what is described with respect to FIG. 8.

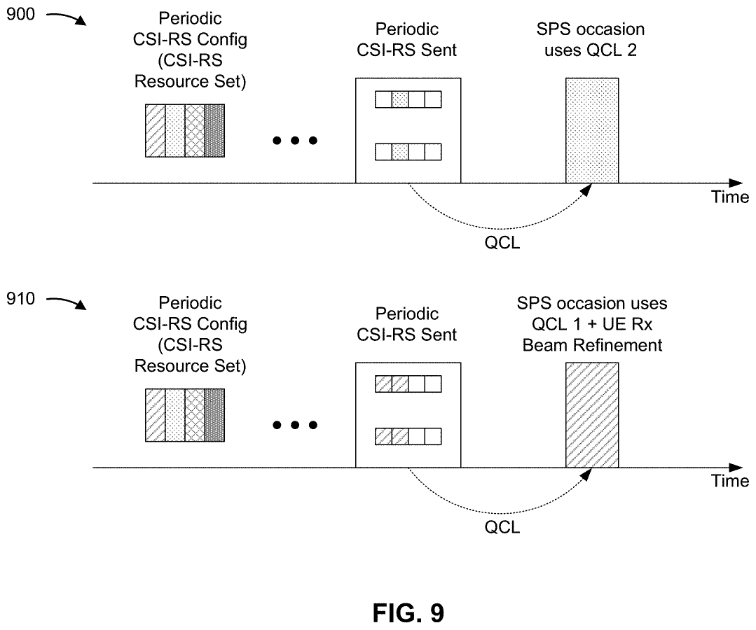

FIG. 9 is a diagram illustrating examples 900 and 910 associated with beam indication using CSI-RSs. As shown in example 900, a configuration for a periodic CSI-RS set identifies a set of CSI-RS resources. Each CSI-RS resource in the set of CSI-RS resources may correspond to a respective TCI state in a set of TCI states. A periodic CSI-RS transmission sent from a base station (e.g., base station 110) to a UE (e.g., UE 120) may include a single CSI-RS on a second CSI-RS resource of the set of CSI-RS resources. The use of the second CSI-RS resource for the CSI-RS provides an indication to the UE to use one or more QCL parameters (QCL2) associated with the TCI state corresponding to the second CSI-RS resource for one or more subsequent communications. The UE and/or base station may then use the one or more QCL parameters (QCL2) associated with the TCI state corresponding to the second CSI-RS resource for a subsequent SPS occasion and/or for one or more other subsequent communications.

As shown in example 910 of FIG. 9, a configuration for a periodic CSI-RS set identifies a set of CSI-RS resources. Each CSI-RS resource in the set of CSI-RS resources may correspond to a respective TCI state in a set of TCI states. A periodic CSI-RS transmission sent from a base station (e.g., base station 110) to a UE (e.g., UE 120) may include a repetition of a CSI-RS associated with a first TCI state corresponding to a first CSI-RS resource of the set of CSI-RS resources. For example, the CSI-RS associated with the first TCI state may be transmitted in the first CSI-RS resource and also in a second CSI-RS resource of the set of CSI-RS resources. The CSI-RS associated with the first TCI state provides an indication to the UE to use one or more QCL parameters (QCL1) associated with the first TCI state for one or more subsequent communications. The CSI-RS may be repeatedly transmitted on a single transmit beam and the TCI state associated with the CSI-RS may be a TCI state of the single transmit beam used to repeatedly transmit the CSI-RS. The UE 120 may be configured to determine the TCI state associated with the CSI-RS (e.g., the TCI state of the single transmit beam used to transmit the CSI-RS) and/or determine which CSI-RS resource of the set of CSI-RS resources corresponds to the TCI state associated with the CSI-RS. Thus, the UE may identify the TCI state and associated QCL parameters (QCL1) from the repeatedly transmitted CSI-RS. The repetition of the CSI-RS associated with the first TCI state multiple times in the set of CSI-RS resources enables the UE 120 to perform beam refinement based on the repeated CSI-RS by sweeping through one or more UE receive beams in multiple transmission instants times. The one or more QCL parameters (QCL1) associated with the first TCI state and the UE receive beam refinement may be used for a subsequent SPS occasion, and/or for one or more other subsequent communications.

As indicated above, FIG. 9 is provided as an example. Other examples may differ from what is described with respect to FIG. 9.

FIG. 10 is a flowchart of an example method 1000 of wireless communication. The method 1000 may be performed by, for example, a UE (e.g., UE 120).

At 1010, the UE may receive a configuration that indicates a CSI-RS resource set. For example, the UE (e.g., using receive processor 258, transmit processor 264, controller/processor 280, and/or memory 282) may receive a configuration that indicates a CSI-RS resource set, as described above in connection with FIG. 4 and at 405. In some aspects, a first set of parameters of the CSI-RS resource set depends on a second set of parameters of at least one of a message that triggers CSI-RS monitoring for the CSI-RS resource set, a physical channel associated with the CSI-RS monitoring, or an uplink reference signal associated with the CSI-RS monitoring. In some aspects, the second set of parameters is for the message that triggers the CSI-RS monitoring, and the message includes at least one of DCI, an MAC-CE, or a combination thereof. In some aspects, the second set of parameters is for the physical channel associated with the CSI-RS monitoring, and the physical channel includes at least one of a PDSCH, a PDCCH, a PUSCH, a PUCCH, or a combination thereof. In some aspects, the second set of parameters is for the uplink reference signal associated with the CSI-RS monitoring, and the uplink reference signal is an SRS.

At 1020, the UE may monitor for one or more CSI-RSs, included in the CSI-RS resource set, based at least in part on the first set of parameters. For example, the UE (e.g., using receive processor 258, transmit processor 264, controller/processor 280, and/or memory 282) may monitor for one or more CSI-RSs, included in the CSI-RS resource set, based at least in part on the first set of parameters, as described above in connection with FIG. 4 and at 415. In some aspects, the CSI-RS monitoring is aperiodically triggered by DCI that includes an uplink grant or a downlink grant associated with the physical channel or the uplink reference signal. In some aspects, the CSI-RS monitoring is aperiodically triggered by an MAC-CE. In some aspects, the CSI-RS monitoring is configured or triggered for semi-persistent monitoring. In some aspects, the CSI-RS monitoring is periodic, and periodic CSI-RS monitoring is configured in the configuration.

In some aspects, a linkage between the first set of parameters and the second set of parameters is indicated in the configuration. In some aspects, the linkage is overridden or modified in the message that triggers the CSI-RS monitoring. In some aspects, a linkage between the first set of parameters and the second set of parameters is indicated in the message that triggers the CSI-RS monitoring.

In some aspects, the first set of parameters includes a bandwidth for the CSI-RS monitoring. In some aspects, the bandwidth for the CSI-RS monitoring is the same as or is a function of a bandwidth for the message that triggers CSI-RS monitoring for the CSI-RS resource set, the physical channel associated with the CSI-RS monitoring, or the uplink reference signal associated with the CSI-RS monitoring.

In some aspects, the first set of parameters includes a timing offset for the CSI-RS monitoring. In some aspects, the timing offset for the CSI-RS monitoring is based at least in part on a timing of the message that triggers CSI-RS monitoring for the CSI-RS resource set, the physical channel associated with the CSI-RS monitoring, or the uplink reference signal associated with the CSI-RS monitoring.

In some aspects, the first set of parameters includes a QCL relationship for the CSI-RS monitoring. In some aspects, the QCL relationship for the CSI-RS monitoring is based at least in part on a QCL relationship of the message that triggers CSI-RS monitoring for the CSI-RS resource set, the physical channel associated with the CSI-RS monitoring, or the uplink reference signal associated with the CSI-RS monitoring.

At 1030, the UE may receive the one or more CSI-RSs included in the CSI-RS resource set. For example, the UE (e.g., using receive processor 258, transmit processor 264, controller/processor 280, and/or memory 282) may receive the one or more CSI-RSs included in the CSI-RS resource set, as described above in connection with FIG. 4 and at 420. In some aspects, a timing between the one or more CSI-RSs and at least one of the uplink reference signal or a communication on the physical channel satisfies a switching delay threshold. In some aspects, the switching delay threshold is indicated in at least one of the configuration, the message that triggers CSI-RS monitoring, or a combination thereof. In some aspects, the switching delay threshold is based at least in part on a capability of the UE.

Although FIG. 10 shows example blocks of method 1000, in some aspects, method 1000 may include additional blocks, fewer blocks, different blocks, or differently arranged blocks than those depicted in FIG. 10. Additionally, or alternatively, two or more of the blocks of method 1000 may be performed in parallel.

FIG. 11 is a flowchart of an example method 1100 of wireless communication. The method 1100 may be performed by, for example, a base station (e.g., base station 110).

At 1110, the base station may transmit, to a UE, a configuration that indicates a CSI-RS resource set. For example, the base station (e.g., using transmit processor 220, receive processor 238, controller/processor 240, and/or memory 242) may transmit, to a UE, a configuration that indicates a CSI-RS resource set, as described above in connection with FIG. 4 and at 405. In some aspects, a first set of parameters of the CSI-RS resource set depends on a second set of parameters of at least one of a message that triggers CSI-RS monitoring for the CSI-RS resource set, a physical channel associated with the CSI-RS monitoring, or an uplink reference signal associated with the CSI-RS monitoring. In some aspects, the second set of parameters is for the message that triggers the CSI-RS monitoring, and the message includes at least one of DCI, an MAC-CE, or a combination thereof. In some aspects, the second set of parameters is for the physical channel associated with the CSI-RS monitoring, and the physical channel includes at least one of a PDSCH, a PDCCH, a PUSCH, a PUCCH, or a combination thereof. In some aspects, the second set of parameters is for the uplink reference signal associated with the CSI-RS monitoring, and the uplink reference signal is an SRS. In some aspects, a linkage between the first set of parameters and the second set of parameters is indicated in the configuration.

At 1120, the base station may transmit, to the UE, a message that triggers CSI-RS monitoring. For example, the base station (e.g., using transmit processor 220, receive processor 238, controller/processor 240, and/or memory 242) may transmit, to the UE, a message that triggers CSI-RS monitoring, as described above in connection with FIG. 4 and at 410. In some aspects, the CSI-RS monitoring is aperiodically triggered by DCI that includes an uplink grant or a downlink grant associated with the physical channel or the uplink reference signal. In some aspects, the CSI-RS monitoring is aperiodically triggered by an MAC-CE. In some aspects, the CSI-RS monitoring is configured or triggered for semi-persistent monitoring. In some aspects, the linkage indicated in the configuration is overridden or modified in the message that triggers the CSI-RS monitoring. In some aspects, a linkage between the first set of parameters and the second set of parameters is indicated in the message that triggers the CSI-RS monitoring.

At 1130, the base station may transmit one or more CSI-RSs, included in the CSI-RS resource set, based at least in part on the first set of parameters. For example, the base station (e.g., using transmit processor 220, receive processor 238, controller/processor 240, and/or memory 242) may transmit one or more CSI-RSs, included in the CSI-RS resource set, based at least in part on the first set of parameters, as described above in connection with FIG. 4 and at 420. In some aspects, the CSI-RS monitoring is periodic, and periodic CSI-RS monitoring is configured in the configuration. In some aspects, the first set of parameters includes a bandwidth for the CSI-RS monitoring. In some aspects, the first set of parameters includes a QCL relationship for the CSI-RS monitoring.

In some aspects, the bandwidth for the CSI-RS monitoring is the same as or is a function of a bandwidth for the message that triggers CSI-RS monitoring for the CSI-RS resource set, the physical channel associated with the CSI-RS monitoring, or the uplink reference signal associated with the CSI-RS monitoring. In some aspects, the first set of parameters includes a timing offset for the CSI-RS monitoring. In some aspects, the timing offset for the CSI-RS monitoring is based at least in part on a timing of the message that triggers CSI-RS monitoring for the CSI-RS resource set, the physical channel associated with the CSI-RS monitoring, or the uplink reference signal associated with the CSI-RS monitoring. In some aspects, the QCL relationship for the CSI-RS monitoring is based at least in part on a QCL relationship of the message that triggers CSI-RS monitoring for the CSI-RS resource set, the physical channel associated with the CSI-RS monitoring, or the uplink reference signal associated with the CSI-RS monitoring.

In some aspects, a timing between the one or more CSI-RSs and at least one of the uplink reference signal or a communication on the physical channel satisfies a switching delay threshold. In some aspects, the switching delay threshold is indicated in at least one of the configuration, the message that triggers CSI-RS monitoring, or a combination thereof. In some aspects, the switching delay threshold is based at least in part on a capability of the UE.

Although FIG. 11 shows example blocks of method 1100, in some aspects, method 1100 may include additional blocks, fewer blocks, different blocks, or differently arranged blocks than those depicted in FIG. 11. Additionally, or alternatively, two or more of the blocks of method 1100 may be performed in parallel.

FIG. 12 is a flowchart of an example method 1200 of wireless communication. The method 1200 may be performed by, for example, a UE (e.g., UE 120).

At 1210, the UE may receive a configuration that indicates a set of CSI-RS resources, included in a CSI-RS resource set, and a set of TCI states corresponding to the set of CSI-RS resources. For example, the UE (e.g., using receive processor 258, transmit processor 264, controller/processor 280, and/or memory 282) may receive a configuration that indicates a set of CSI-RS resources, included in a CSI-RS resource set, and a set of TCI states corresponding to the set of CSI-RS resources, as described above in connection with FIG. 8 and at 805. In some aspects, the set of CSI-RS resources may include a plurality of CSI-RS resources allocated for a periodic CSI-RS transmission. In some aspects, the configuration may indicate a periodicity for the periodic CSI-RS transmission.

At 1220, the UE may receive one or more CSI-RSs in one or more CSI-RS resources included in the set of CSI-RS resources. For example, the UE (e.g., using receive processor 258, transmit processor 264, controller/processor 280, and/or memory 282) may receive one or more CSI-RSs in one or more CSI-RS resources included in the set of CSI-RS resources, as described above in connection with FIG. 8 and at 810. In some aspects, the one or more CSI-RSs are associated with one or more TCI states that are a subset of the set of TCI states corresponding to the set of CSI-RS resources. In some aspects, the one or more CSI-RSs consist of only a single CSI-RS, wherein the one or more CSI-RS resources consist of only a single CSI-RS resource included in the set of CSI-RS resources, and wherein the one or more TCI states consist of only a single TCI state associated with the single CSI-RS. In some aspects, the one or more CSI-RSs consist of only a single CSI-RS, associated with only a single TCI state, that is repeated in multiple CSI-RS resources of the one or more CSI-RS resources.

At 1230, the UE may identify one or more QCL parameters to be used for one or more communications subsequent to the one or more CSI-RSs based at least in part on the one or more TCI states. For example, the UE (e.g., using receive processor 258, transmit processor 264, controller/processor 280, and/or memory 282) may identify one or more QCL parameters to be used for one or more communications subsequent to the one or more CSI-RSs based at least in part on the one or more TCI states, as described above in connection with FIG. 8 and at 815. In some aspects, the one or more communications are one or more downlink communications, and the one or more QCL parameters are one or more TCI states corresponding to the one or more downlink communications. In some aspects, the one or more TCI states corresponding to the one or more downlink communications are the same as the one or more TCI states associated with the one or more CSI-RSs. In some aspects, the one or more communications are one or more uplink communications, and the one or more QCL parameters are one or more spatial relations corresponding to the one or more uplink communications. In some aspects, the one or more spatial relations corresponding to the one or more uplink communications are associated with a same spatial domain transmission filter or precoder as the one or more TCI states associated with the one or more CSI-RSs.

In some aspects, the one or more communications are associated with a time window that is based at least in part on a time domain resource in which the one or more CSI-RSs are received. In some aspects, the time window is defined by a number of time domain resources or a number of communications. In some aspects, the time window is signaled to the UE in at least one of the configuration, DCI, a MAC-CE, or a combination thereof. In some aspects, the time window is indicated to the UE based at least in part on the one or more CSI-RS resources in which the one or more CSI-RSs are received.

In some aspects, the one or more QCL parameters are applicable to one or more specific types of messages, one or more specific channels, one or more message configurations, or a combination thereof. In some aspects, the one or more QCL parameters are applicable to all types of messages, all channels, all message configurations, or a combination thereof.

In some aspects, the one or more QCL parameters are applicable to a set of communications that occur at least a threshold amount of time after reception of the one or more CSI-RSs. In some aspects, the threshold amount of time is based at least in part on a capability of the UE. In some aspects, the one or more QCL parameters are applicable to a first set of communications that occur at least a threshold amount of time after reception of the one or more CSI-RSs if the one or more QCL parameters have changed in comparison to another one or more QCL parameters used for a communication that occurs prior to reception of the one or more CSI-RSs, and the other one or more QCL parameters are applicable to a second set of communications that occur less than the threshold amount of time after reception of the one or more CSI-RSs if the one or more QCL parameters have changed in comparison to the other one or more QCL parameters.

In some aspects, the one or more communications include multiple communications that use multiple TCI states, wherein at least one TCI state of the multiple TCI states is indicated based at least in part on the one or more TCI states associated with the one or more CSI-RSs. In some aspects, at least one other TCI state, of the multiple TCI states, is indicated based at least in part on: the one or more TCI states associated with the one or more CSI-RSs, the configuration or another signaling message, a rule associated with the at least one TCI state, a rule associated with an order in which the one or more CSI-RSs are received, or a combination thereof.

Although FIG. 12 shows example blocks of method 1200, in some aspects, method 1200 may include additional blocks, fewer blocks, different blocks, or differently arranged blocks than those depicted in FIG. 12. Additionally, or alternatively, two or more of the blocks of method 1200 may be performed in parallel.

FIG. 13 is a flowchart of an example method 1300 of wireless communication. The method 1300 may be performed by, for example, a base station (e.g., base station 110).

At 1310, the base station may transmit a configuration that indicates a set of CSI-RS resources, included in a CSI-RS resource set, and a set of TCI states corresponding to the set of CSI-RS resources. For example, the base station (e.g., using transmit processor 220, receive processor 238, controller/processor 240, and/or memory 242) may transmit a configuration that indicates a set of CSI-RS resources, included in a CSI-RS resource set, and a set of TCI states corresponding to the set of CSI-RS resources, as described above in connection with FIG. 8 and at 805. In some aspects, the set of CSI-RS resources may include a plurality of CSI-RS resources allocated for a periodic CSI-RS transmission. In some aspects, the configuration may indicate a periodicity for the periodic CSI-RS transmission.

At 1320, the base station may transmit one or more CSI-RSs in one or more CSI-RS resources included in the set of CSI-RS resources. For example, the base station (e.g., using transmit processor 220, receive processor 238, controller/processor 240, and/or memory 242) may transmit one or more CSI-RSs in one or more CSI-RS resources included in the set of CSI-RS resources, as described above in connection with FIG. 8 and at 810. In some aspects, the one or more CSI-RSs are associated with one or more TCI states that are a subset of the set of TCI states corresponding to the set of CSI-RS resources. In some aspects, the one or more TCI states indicate one or more QCL parameters to be used for one or more communications subsequent to the one or more CSI-RSs. In some aspects, the one or more CSI-RSs consist of only a single CSI-RS, wherein the one or more CSI-RS resources consist of only a single CSI-RS resource included in the set of CSI-RS resources, and the one or more TCI states consist of only a single TCI state associated with the single CSI-RS. In some aspects, the one or more CSI-RSs consist of only a single CSI-RS, associated with only a single TCI state, that is repeated in multiple CSI-RS resources of the one or more CSI-RS resources.

In some aspects, the one or more communications include multiple communications that use multiple TCI states, and at least one TCI state of the multiple TCI states is indicated based at least in part on the one or more TCI states associated with the one or more CSI-RSs. In some aspects, at least one other TCI state, of the multiple TCI states, is indicated based at least in part on: the one or more TCI states associated with the one or more CSI-RSs, the configuration or another signaling message, a rule associated with the at least one TCI state, a rule associated with an order in which the one or more CSI-RSs are received, or a combination thereof.

At 1330, the base station may communicate with the UE using one or QCL parameters indicated by one or more TCI states associated with the one or more CSI-RSs. For example, the base station (e.g., using transmit processor 220, receive processor 238, controller/processor 240, and/or memory 242) may communicate with the UE using one or QCL parameters indicated by one or more TCI states associated with the one or more CSI-RSs, as described above in connection with FIG. 8 and at 820. In some aspects, the base station may transmit and/or receive one or more communications to and/or from the UE using the one or more QCL parameters. In some aspects, the one or more communications are one or more downlink communications, and the one or more QCL parameters are one or more TCI states corresponding to the one or more downlink communications. In some aspects, the one or more TCI states corresponding to the one or more downlink communications are the same as the one or more TCI states associated with the one or more CSI-RSs. In some aspects, the one or more communications are one or more uplink communications, and the one or more QCL parameters are one or more spatial relations corresponding to the one or more uplink communications. In some aspects, the one or more spatial relations corresponding to the one or more uplink communications are associated with a same spatial domain transmission filter or precoder as the one or more TCI states associated with the one or more CSI-RSs.

In some aspects, the one or more communications are associated with a time window that is based at least in part on a time domain resource in which the one or more CSI-RSs are received. In some aspects, the time window is defined by a number of time domain resources or a number of communications. In some aspects, the time window is signaled to the UE in at least one of the configuration, DCI, a MAC-CE, or a combination thereof. In some aspects, the time window is indicated to the UE based at least in part on the one or more CSI-RS resources in which the one or more CSI-RSs are received.

In some aspects, the one or more QCL parameters are applicable to one or more specific types of messages, one or more specific channels, one or more message configurations, or a combination thereof. In some aspects, the one or more QCL parameters are applicable to all types of messages, all channels, all message configurations, or a combination thereof.

In some aspects, the one or more QCL parameters are applicable to a set of communications that occur at least a threshold amount of time after reception of the one or more CSI-RSs. In some aspects, the threshold amount of time is based at least in part on a capability of the UE. In some aspects, the one or more QCL parameters are applicable to a first set of communications that occur at least a threshold amount of time after reception of the one or more CSI-RSs if the one or more QCL parameters have changed in comparison to another one or more QCL parameters used for a communication that occurs prior to reception of the one or more CSI-RSs, and the other one or more QCL parameters are applicable to a second set of communications that occur less than the threshold amount of time after reception of the one or more CSI-RSs if the one or more QCL parameters have changed in comparison to the other one or more QCL parameters.

Although FIG. 13 shows example blocks of method 1300, in some aspects, method 1300 may include additional blocks, fewer blocks, different blocks, or differently arranged blocks than those depicted in FIG. 13. Additionally, or alternatively, two or more of the blocks of method 1300 may be performed in parallel.

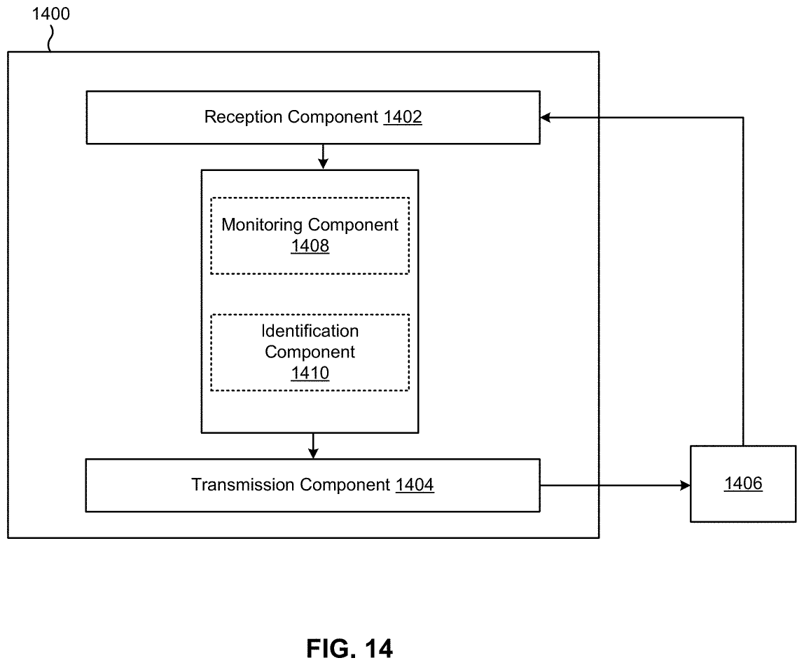

FIG. 14 is a block diagram of an example apparatus 1400 for wireless communication. The apparatus 1400 may be a UE, or a UE may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include a monitoring component 1408 and/or an identification component 1410, among one or more other examples.

In some aspects, the apparatus 1400 may be configured to perform one or more operations described herein in connection with FIGS. 4-6 and/or FIGS. 8-9. Additionally, or alternatively, the apparatus 1400 may be configured to perform one or more processes described herein, such as method 1000 of FIG. 10, method 1200 of FIG. 12, and/or other processes as described herein. In some aspects, the apparatus 1400 and/or one or more components shown in FIG. 14 may include one or more components of the UE described above in connection with FIG. 2. Additionally, or alternatively, one or more components shown in FIG. 14 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1406. In some aspects, the reception component 1402 may include one or more antennas, a demodulator, a MIMO detector, a receive processor, a controller/processor, a memory, or a combination thereof, of the UE described above in connection with FIG. 2.

The transmission component 1404 may transmit communications, such as reference signals, control information, data communications, or a combination thereof, to the apparatus 1406. In some aspects, one or more other components of the apparatus 1406 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modulator, a transmit MIMO processor, a transmit processor, a controller/processor, a memory, or a combination thereof, of the UE described above in connection with FIG. 2. In some aspects, the transmission component 1404 may be collocated with the reception component 1402 in a transceiver.

In some aspects, the reception component 1402 may receive a configuration that indicates a CSI-RS resource set, wherein a first set of parameters of the CSI-RS resource set depends on a second set of parameters of at least one of a message that triggers CSI-RS monitoring for the CSI-RS resource set, a physical channel associated with the CSI-RS monitoring, or an uplink reference signal associated with the CSI-RS monitoring. The monitoring component 1408 may monitor for one or more CSI-RSs, included in the CSI-RS resource set, based at least in part on the first set of parameters.

In some aspects, the reception component 1402 may receive a configuration that indicates a set of CSI-RS resources, included in a CSI-RS resource set, and a set of TCI states corresponding to the set of CSI-RS resources. The reception component 1402 may receive one or more CSI-RSs in one or more CSI-RS resources included in the set of CSI-RS resources, wherein the one or more CSI-RSs are associated with one or more TCI states that are a subset of the set of TCI states corresponding to the set of CSI-RS resources. The identification component 1410 may identify one or more QCL parameters to be used for one or more communications subsequent to the one or more CSI-RS s based at least in part on the one or more TCI states.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

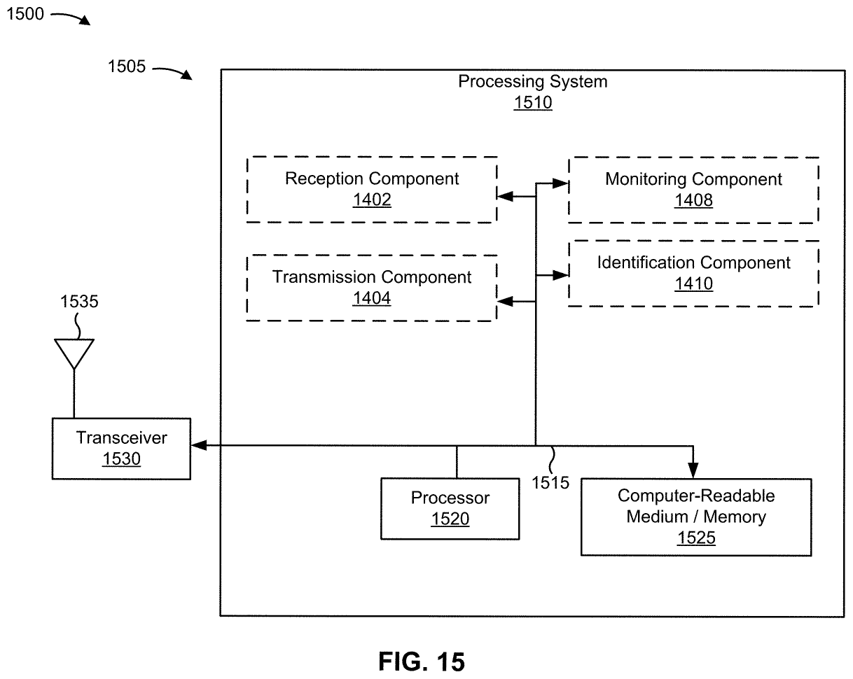

FIG. 15 is a diagram illustrating an example 1500 of a hardware implementation for an apparatus 1505 employing a processing system 1510. The apparatus 1505 may be a UE.

The processing system 1510 may be implemented with a bus architecture, represented generally by the bus 1515. The bus 1515 may include any number of interconnecting buses and bridges depending on the specific application of the processing system 1510 and the overall design constraints. The bus 1515 links together various circuits including one or more processors and/or hardware components, represented by the processor 1520, the illustrated components, and the computer-readable medium/memory 1525. The bus 1515 may also link various other circuits, such as timing sources, peripherals, voltage regulators, power management circuits, or the like.

The processing system 1510 may be coupled to a transceiver 1530. The transceiver 1530 is coupled to one or more antennas 1535. The transceiver 1530 provides a means for communicating with various other apparatuses over a transmission medium. The transceiver 1530 receives a signal from the one or more antennas 1535, extracts information from the received signal, and provides the extracted information to the processing system 1510, specifically the reception component 1402. In addition, the transceiver 1530 receives information from the processing system 1510, specifically the transmission component 1404, and generates a signal to be applied to the one or more antennas 1535 based at least in part on the received information.

The processing system 1510 includes a processor 1520 coupled to a computer-readable medium/memory 1525. The processor 1520 is responsible for general processing, including the execution of software stored on the computer-readable medium/memory 1525. The software, when executed by the processor 1520, causes the processing system 1510 to perform the various functions described herein for any particular apparatus. The computer-readable medium/memory 1525 may also be used for storing data that is manipulated by the processor 1520 when executing software. The processing system further includes at least one of the illustrated components. The components may be software modules running in the processor 1520, resident/stored in the computer readable medium/memory 1525, one or more hardware modules coupled to the processor 1520, or some combination thereof.

In some aspects, the processing system 1510 may be a component of the UE 120 and may include the memory 282 and/or at least one of the TX MIMO processor 266, the RX processor 258, and/or the controller/processor 280. In some aspects, the apparatus 1505 for wireless communication includes means for receiving a CSI-RS resource set, wherein a first set of parameters of the CSI-RS resource set depends on a second set of parameters of at least one of a message that triggers CSI-RS monitoring for the CSI-RS resource set, a physical channel associated with the CSI-RS monitoring, or an uplink reference signal associated with the CSI-RS monitoring; and means for monitoring for one or more CSI-RSs, included in the CSI-RS resource set, based at least in part on the first set of parameters. In some aspects, the apparatus 1505 for wireless communication includes means for receiving a configuration that indicates a set of CSI-RS resources, included in a CSI-RS resource set, and a set of TCI states corresponding to the set of CSI-RS resources; means for receiving one or more CSI-RSs in one or more CSI-RS resources included in the set of CSI-RS resources, wherein the one or more CSI-RSs are associated with one or more TCI states that are a subset of the set of TCI states corresponding to the set of CSI-RS resources; and means for identifying one or more quasi co-location parameters to be used for one or more communications subsequent to the one or more CSI-RSs based at least in part on the one or more TCI states. The aforementioned means may be one or more of the aforementioned components of the apparatus 1400 and/or the processing system 1510 of the apparatus 1505 configured to perform the functions recited by the aforementioned means. As described elsewhere herein, the processing system 1510 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 15 is provided as an example. Other examples may differ from what is described in connection with FIG. 15.

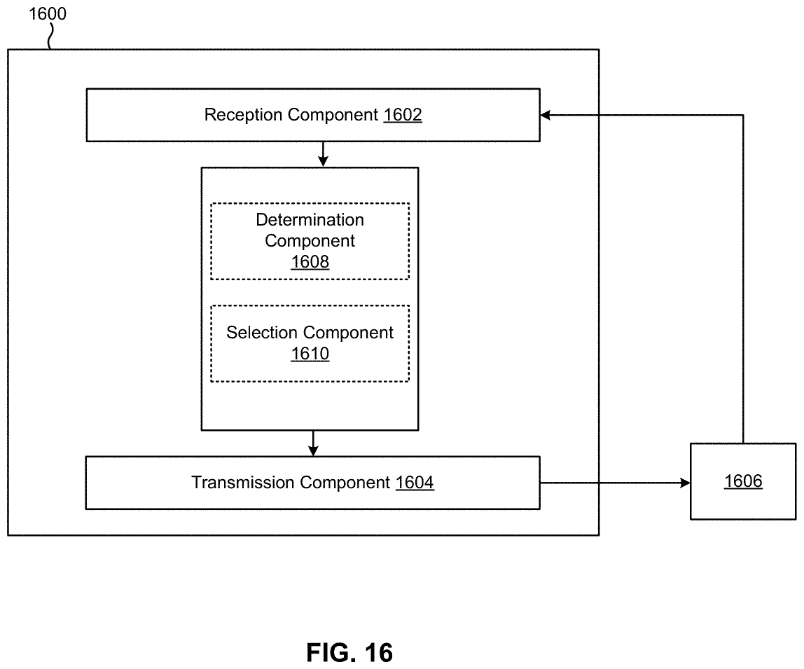

FIG. 16 is a block diagram of an example apparatus 1600 for wireless communication. The apparatus 1600 may be a base station, or a base station may include the apparatus 1600. In some aspects, the apparatus 1600 includes a reception component 1602 and a transmission component 1604, which may be in communication with one another (for example, via one or more buses and/or one or more other components). As shown, the apparatus 1600 may communicate with another apparatus 1606 (such as a UE, a base station, or another wireless communication device) using the reception component 1602 and the transmission component 1604. As further shown, the apparatus 1600 may include a determination component 1608 and/or a selection component 1610, among one or more other examples.

In some aspects, the apparatus 1600 may be configured to perform one or more operations described herein in connection with FIGS. 4-6 and/or FIGS. 8-9. Additionally, or alternatively, the apparatus 1600 may be configured to perform one or more processes described herein, such as method 1100 of FIG. 11, method 1300 of FIG. 13, and/or other processes as described herein. In some aspects, the apparatus 1600 and/or one or more components shown in FIG. 16 may include one or more components of the base station described above in connection with FIG. 2. Additionally, or alternatively, one or more components shown in FIG. 16 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1606. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1606. In some aspects, the reception component 1602 may include one or more antennas, a demodulator, a MIMO detector, a receive processor, a controller/processor, a memory, or a combination thereof, of the base station described above in connection with FIG. 2.

The transmission component 1604 may transmit communications, such as reference signals, control information, data communications, or a combination thereof, to the apparatus 1606. In some aspects, one or more other components of the apparatus 1606 may generate communications and may provide the generated communications to the transmission component 1604 for transmission to the apparatus 1606. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1606. In some aspects, the transmission component 1604 may include one or more antennas, a modulator, a transmit MIMO processor, a transmit processor, a controller/processor, a memory, or a combination thereof, of the base station described above in connection with FIG. 2. In some aspects, the transmission component 1604 may be collocated with the reception component 1602 in a transceiver.

In some aspects, the transmission component 1604 may transmit, to UE, a CSI-RS resource set, wherein a first set of parameters of the CSI-RS resource set depends on a second set of parameters of at least one of a message that triggers CSI-RS monitoring for the CSI-RS resource set, a physical channel associated with the CSI-RS monitoring, or an uplink reference signal associated with the CSI-RS monitoring. The transmission component 1604 may transmit one or more CSI-RSs, included in the CSI-RS resource set, based at least in part on the first set of parameters. The determination component 1608 may determine one or more values for the second set parameters in order to dynamically set or adjust values for the first set of parameters.

In some aspects, the transmission component 1604 may transmit a configuration that indicates a set of CSI-RS resources, included in a CSI-RS resource set, and a set of TCI states corresponding to the set of CSI-RS resources. The selection component 1610 may select one or more CSI-RS associated with one or more TCI states to provide an indication of one or more QCL parameters. The transmission component 1604 may transmit one or more CSI-RSs in one or more CSI-RS resources included in the set of CSI-RS resources, wherein the one or more CSI-RSs are associated with one or more TCI states that are a subset of the set of TCI states corresponding to the set of CSI-RS resources, and wherein the one or more TCI states indicate one or more quasi co-location parameters to be used for one or more communications subsequent to the one or more CSI-RSs

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

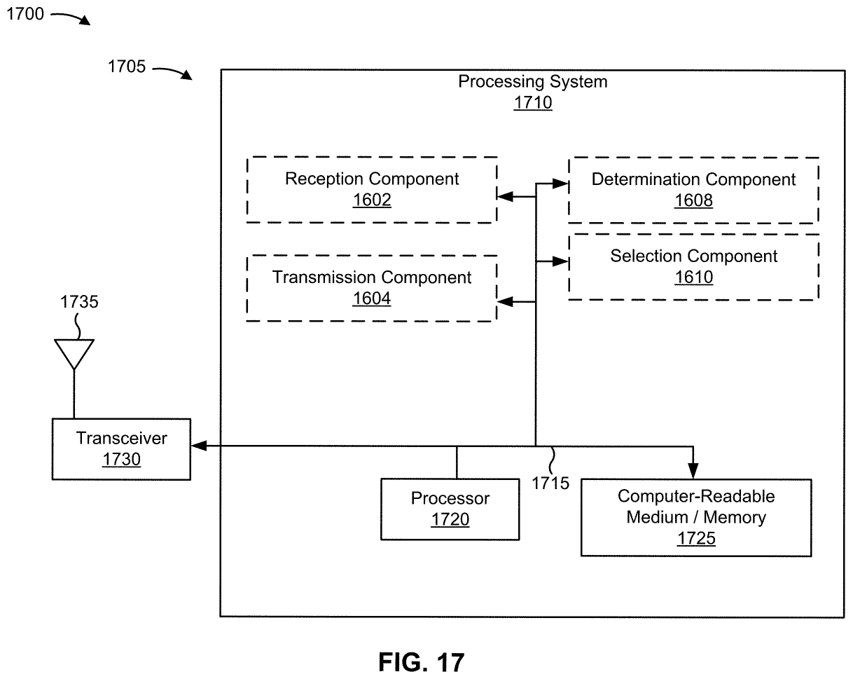

FIG. 17 is a diagram illustrating an example 1700 of a hardware implementation for an apparatus 1705 employing a processing system 1710. The apparatus 1705 may be a base station.

The processing system 1710 may be implemented with a bus architecture, represented generally by the bus 1715. The bus 1715 may include any number of interconnecting buses and bridges depending on the specific application of the processing system 1710 and the overall design constraints. The bus 1715 links together various circuits including one or more processors and/or hardware components, represented by the processor 1720, the illustrated components, and the computer-readable medium/memory 1725. The bus 1715 may also link various other circuits, such as timing sources, peripherals, voltage regulators, power management circuits, or the like.

The processing system 1710 may be coupled to a transceiver 1730. The transceiver 1730 is coupled to one or more antennas 1735. The transceiver 1730 provides a means for communicating with various other apparatuses over a transmission medium. The transceiver 1730 receives a signal from the one or more antennas 1735, extracts information from the received signal, and provides the extracted information to the processing system 1710, specifically the reception component 1602. In addition, the transceiver 1730 receives information from the processing system 1710, specifically the transmission component 1604, and generates a signal to be applied to the one or more antennas 1735 based at least in part on the received information.

The processing system 1710 includes a processor 1720 coupled to a computer-readable medium/memory 1725. The processor 1720 is responsible for general processing, including the execution of software stored on the computer-readable medium/memory 1725. The software, when executed by the processor 1720, causes the processing system 1710 to perform the various functions described herein for any particular apparatus. The computer-readable medium/memory 1725 may also be used for storing data that is manipulated by the processor 1720 when executing software. The processing system further includes at least one of the illustrated components. The components may be software modules running in the processor 1720, resident/stored in the computer readable medium/memory 1725, one or more hardware modules coupled to the processor 1720, or some combination thereof.

In some aspects, the processing system 1710 may be a component of the base station 110 and may include the memory 242 and/or at least one of the TX MIMO processor 230, the RX processor 238, and/or the controller/processor 240. In some aspects, the apparatus 1705 for wireless communication includes means for transmitting, to a UE, a configuration that indicates a CSI-RS resource set, wherein a first set of parameters of the CSI-RS resource set depends on a second set of parameters of at least one of a message that triggers CSI-RS monitoring for the CSI-RS resource set, a physical channel associated with the CSI-RS monitoring, or an uplink reference signal associated with the CSI-RS monitoring; and means for transmitting one or more CSI-RSs, included in the CSI-RS resource set, based at least in part on the first set of parameters. In some aspects, the apparatus 1705 for wireless communication includes means for transmitting a configuration that indicates a set of CSI-RS resources, included in a CSI-RS resource set, and a set of TCI states corresponding to the set of CSI-RS resources; and means for transmitting one or more CSI-RSs in one or more CSI-RS resources included in the set of CSI-RS resources, wherein the one or more CSI-RSs are associated with one or more TCI states that are a subset of the set of TCI states corresponding to the set of CSI-RS resources, and wherein the one or more TCI states indicate one or more quasi co-location parameters to be used for one or more communications subsequent to the one or more CSI-RSs. The aforementioned means may be one or more of the aforementioned components of the apparatus 1600 and/or the processing system 1710 of the apparatus 1705 configured to perform the functions recited by the aforementioned means. As described elsewhere herein, the processing system 1710 may include the TX MIMO processor 230, the receive processor 238, and/or the controller/processor 240. In one configuration, the aforementioned means may be the TX MIMO processor 230, the receive processor 238, and/or the controller/processor 240 configured to perform the functions and/or operations recited herein.

FIG. 17 is provided as an example. Other examples may differ from what is described in connection with FIG. 17.

The following provides an overview of some Aspects of the present disclosure:

Aspect 1: A method of wireless communication performed by a user equipment (UE), comprising: receiving a configuration that indicates a channel state information reference signal (CSI-RS) resource set, wherein a first set of parameters of the CSI-RS resource set depends on a second set of parameters of at least one of a message that triggers CSI-RS monitoring for the CSI-RS resource set, a physical channel associated with the CSI-RS monitoring, or an uplink reference signal associated with the CSI-RS monitoring; and monitoring for one or more CSI-RSs, included in the CSI-RS resource set, based at least in part on the first set of parameters.

Aspect 2: The method of Aspect 1, wherein the second set of parameters is for the message that triggers the CSI-RS monitoring, and wherein the message includes at least one of downlink control information, a medium access control (MAC) control element, or a combination thereof.

Aspect 3: The method of Aspect 1, wherein the second set of parameters is for the physical channel associated with the CSI-RS monitoring, wherein the physical channel includes at least one of a physical downlink shared channel, a physical downlink control channel, a physical uplink shared channel, a physical uplink control channel, or a combination thereof.

Aspect 4: The method of Aspect 1, wherein the second set of parameters is for the uplink reference signal associated with the CSI-RS monitoring, wherein the uplink reference signal is a sounding reference signal.

Aspect 5: The method of any of Aspects 1-4, wherein the CSI-RS monitoring is aperiodically triggered by downlink control information that includes an uplink grant or a downlink grant associated with the physical channel or the uplink reference signal.

Aspect 6: The method of any of Aspects 1-4, wherein the CSI-RS monitoring is aperiodically triggered by a medium access control (MAC) control element.

Aspect 7: The method of any of Aspects 1-4, wherein the CSI-RS monitoring is configured or triggered for semi-persistent monitoring.

Aspect 8: The method of any of Aspects 1-4, wherein the CSI-RS monitoring is periodic, and wherein periodic CSI-RS monitoring is configured in the configuration.

Aspect 9: The method of any of Aspects 1-8, wherein a linkage between the first set of parameters and the second set of parameters is indicated in the configuration.

Aspect 10: The method of Aspect 9, wherein the linkage is overridden or modified in the message that triggers the CSI-RS monitoring.

Aspect 11: The method of any of Aspects 1-10, wherein a linkage between the first set of parameters and the second set of parameters is indicated in the message that triggers the CSI-RS monitoring.

Aspect 12: The method of any of Aspects 1-11, wherein the first set of parameters includes a bandwidth for the CSI-RS monitoring.

Aspect 13: The method of Aspect 12, wherein the bandwidth for the CSI-RS monitoring is the same as or is a function of a bandwidth for the message that triggers CSI-RS monitoring for the CSI-RS resource set, the physical channel associated with the CSI-RS monitoring, or the uplink reference signal associated with the CSI-RS monitoring.

Aspect 14: The method of any of Aspects 1-13, wherein the first set of parameters includes a timing offset for the CSI-RS monitoring.

Aspect 15: The method of Aspect 14, wherein the timing offset for the CSI-RS monitoring is based at least in part on a timing of the message that triggers CSI-RS monitoring for the CSI-RS resource set, the physical channel associated with the CSI-RS monitoring, or the uplink reference signal associated with the CSI-RS monitoring.

Aspect 16: The method of any of Aspects 1-15, wherein the first set of parameters includes a quasi co-location relationship for the CSI-RS monitoring.

Aspect 17: The method of Aspect 16, wherein the quasi co-location relationship for the CSI-RS monitoring is based at least in part on a quasi co-location relationship of the message that triggers CSI-RS monitoring for the CSI-RS resource set, the physical channel associated with the CSI-RS monitoring, or the uplink reference signal associated with the CSI-RS monitoring.

Aspect 18: The method of any of Aspects 1-17, wherein a timing between the one or more CSI-RSs and at least one of the uplink reference signal or a communication on the physical channel satisfies a switching delay threshold.

Aspect 19: The method of Aspect 18, wherein the switching delay threshold is indicated in at least one of the configuration or the message that triggers CSI-RS monitoring.

Aspect 20: The method of any of Aspects 18-19, wherein the switching delay threshold is based at least in part on a capability of the UE.

Aspect 21: A method of wireless communication performed by a base station, comprising: transmitting, to a user equipment (UE), a configuration that indicates a channel state information reference signal (CSI-RS) resource set, wherein a first set of parameters of the CSI-RS resource set depends on a second set of parameters of at least one of a message that triggers CSI-RS monitoring for the CSI-RS resource set, a physical channel associated with the CSI-RS monitoring, or an uplink reference signal associated with the CSI-RS monitoring; and transmitting one or more CSI-RSs, included in the CSI-RS resource set, based at least in part on the first set of parameters.

Aspect 22: The method of Aspect 21, wherein the second set of parameters is for the message that triggers the CSI-RS monitoring, and wherein the message includes at least one of downlink control information, a medium access control (MAC) control element, or a combination thereof.

Aspect 23: The method of Aspect 21, wherein the second set of parameters is for the physical channel associated with the CSI-RS monitoring, wherein the physical channel includes at least one of a physical downlink shared channel, a physical downlink control channel, a physical uplink shared channel, a physical uplink control channel, or a combination thereof.

Aspect 24: The method of Aspect 21, wherein the second set of parameters is for the uplink reference signal associated with the CSI-RS monitoring, wherein the uplink reference signal is a sounding reference signal.

Aspect 25: The method of any of Aspects 21-24, wherein the CSI-RS monitoring is aperiodically triggered by downlink control information that includes an uplink grant or a downlink grant associated with the physical channel or the uplink reference signal.

Aspect 26: The method of any of Aspects 21-24, wherein the CSI-RS monitoring is aperiodically triggered by a medium access control (MAC) control element.

Aspect 27: The method of any of Aspects 21-24, wherein the CSI-RS monitoring is configured or triggered for semi-persistent monitoring.

Aspect 28: The method of any of Aspects 21-24, wherein the CSI-RS monitoring is periodic, and wherein periodic CSI-RS monitoring is configured in the configuration.

Aspect 29: The method of any of Aspects 21-28, wherein a linkage between the first set of parameters and the second set of parameters is indicated in the configuration.

Aspect 30: The method of Aspect 29, wherein the linkage is overridden or modified in the message that triggers the CSI-RS monitoring.

Aspect 31: The method of any of Aspects 21-30, wherein a linkage between the first set of parameters and the second set of parameters is indicated in the message that triggers the CSI-RS monitoring.

Aspect 32: The method of any of Aspects 21-31, wherein the first set of parameters includes a bandwidth for the CSI-RS monitoring.

Aspect 33: The method of Aspect 32, wherein the bandwidth for the CSI-RS monitoring is the same as or is a function of a bandwidth for the message that triggers CSI-RS monitoring for the CSI-RS resource set, the physical channel associated with the CSI-RS monitoring, or the uplink reference signal associated with the CSI-RS monitoring.

Aspect 34: The method of any of Aspects 21-33, wherein the first set of parameters includes a timing offset for the CSI-RS monitoring.

Aspect 35: The method of Aspect 34, wherein the timing offset for the CSI-RS monitoring is based at least in part on a timing of the message that triggers CSI-RS monitoring for the CSI-RS resource set, the physical channel associated with the CSI-RS monitoring, or the uplink reference signal associated with the CSI-RS monitoring.

Aspect 36: The method of any of Aspects 21-35, wherein the first set of parameters includes a quasi co-location relationship for the CSI-RS monitoring.

Aspect 37: The method of Aspect 36, wherein the quasi co-location relationship for the CSI-RS monitoring is based at least in part on a quasi co-location relationship of the message that triggers CSI-RS monitoring for the CSI-RS resource set, the physical channel associated with the CSI-RS monitoring, or the uplink reference signal associated with the CSI-RS monitoring.

Aspect 38: The method of any of Aspects 21-37, wherein a timing between the one or more CSI-RSs and at least one of the uplink reference signal or a communication on the physical channel satisfies a switching delay threshold.

Aspect 39: The method of Aspect 38, wherein the switching delay threshold is indicated in at least one of the configuration, the message that triggers CSI-RS monitoring, or a combination thereof.

Aspect 40: The method of any of Aspects 38-39, wherein the switching delay threshold is based at least in part on a capability of the UE.

Aspect 41: A method of wireless communication performed by a user equipment (UE), comprising: receiving a configuration that indicates a set of channel state information reference signal (CSI-RS) resources, included in a CSI-RS resource set, and a set of transmission configuration indicator (TCI) states corresponding to the set of CSI-RS resources; receiving one or more CSI-RSs in one or more CSI-RS resources included in the set of CSI-RS resources, wherein the one or more CSI-RSs are associated with one or more TCI states that are a subset of the set of TCI states corresponding to the set of CSI-RS resources; and identifying one or more quasi co-location parameters to be used for one or more communications subsequent to the one or more CSI-RSs based at least in part on the one or more TCI states.

Aspect 42: The method of Aspect 41, wherein the one or more communications are one or more downlink communications, and wherein the one or more quasi co-location parameters are one or more TCI states corresponding to the one or more downlink communications.

Aspect 43: The method of Aspect 42, wherein the one or more TCI states corresponding to the one or more downlink communications are the same as the one or more TCI states associated with the one or more CSI-RSs.

Aspect 44: The method of Aspect 41, wherein the one or more communications are one or more uplink communications, and wherein the one or more quasi co-location parameters are one or more spatial relations corresponding to the one or more uplink communications.

Aspect 45: The method of Aspect 44, wherein the one or more spatial relations corresponding to the one or more uplink communications are associated with a same spatial domain transmission filter or precoder as the one or more TCI states associated with the one or more CSI-RSs.

Aspect 46: The method of any of Aspects 41-45, wherein the one or more communications are associated with a time window that is based at least in part on a time domain resource in which the one or more CSI-RSs are received.

Aspect 47: The method of Aspect 46, wherein the time window is defined by a number of time domain resources or a number of communications.

Aspect 48: The method of any of Aspects 46-47, wherein the time window is signaled to the UE in at least one of the configuration, downlink control information, a medium access control (MAC) control element, or a combination thereof.

Aspect 49: The method of any of Aspects 46-47, wherein the time window is indicated to the UE based at least in part on the one or more CSI-RS resources in which the one or more CSI-RSs are received.

Aspect 50: The method of any of Aspects 41-49, wherein the one or more quasi co-location parameters are applicable to one or more specific types of messages, one or more specific channels, one or more message configurations, or a combination thereof.

Aspect 51: The method of any of Aspects 41-49, wherein the one or more quasi co-location parameters are applicable to all types of messages, all channels, all message configurations, or a combination thereof.

Aspect 52: The method of any of Aspects 41-51, wherein the one or more quasi co-location parameters are applicable to a set of communications that occur at least a threshold amount of time after reception of the one or more CSI-RSs.

Aspect 53: The method of Aspect 52, wherein the threshold amount of time is based at least in part on a capability of the UE.

Aspect 54: The method of any of Aspects 41-53, wherein the one or more quasi co-location parameters are applicable to a first set of communications that occur at least a threshold amount of time after reception of the one or more CSI-RSs if the one or more quasi co-location parameters have changed in comparison to another one or more quasi co-location parameters used for a communication that occurs prior to reception of the one or more CSI-RSs, and wherein the other one or more quasi co-location parameters are applicable to a second set of communications that occur less than the threshold amount of time after reception of the one or more CSI-RSs if the one or more quasi co-location parameters have changed in comparison to the other one or more quasi co-location parameters.

Aspect 55: The method of any of Aspects 41-54, wherein the one or more communications include multiple communications that use multiple TCI states, wherein at least one TCI state of the multiple TCI states is indicated based at least in part on the one or more TCI states associated with the one or more CSI-RSs.

Aspect 56: The method of Aspect 55, wherein at least one other TCI state, of the multiple TCI states, is indicated based at least in part on: the one or more TCI states associated with the one or more CSI-RSs, the configuration or another signaling message, a rule associated with the at least one TCI state, a rule associated with an order in which the one or more CSI-RSs are received, or a combination thereof.

Aspect 57: The method of any of Aspects 41-54, wherein the one or more CSI-RSs consist of only a single CSI-RS, wherein the one or more CSI-RS resources consist of only a single CSI-RS resource included in the set of CSI-RS resources, and wherein the one or more TCI states consist of only a single TCI state associated with the single CSI-RS.

Aspect 58: The method of any of Aspects 41-54, wherein the one or more CSI-RSs consist of only a single CSI-RS, associated with only a single TCI state, that is repeated in multiple CSI-RS resources of the one or more CSI-RS resources.

Aspect 59: A method of wireless communication performed by a base station, comprising: transmitting a configuration that indicates a set of channel state information reference signal (CSI-RS) resources, included in a CSI-RS resource set, and a set of transmission configuration indicator (TCI) states corresponding to the set of CSI-RS resources; and transmitting one or more CSI-RSs in one or more CSI-RS resources included in the set of CSI-RS resources, wherein the one or more CSI-RSs are associated with one or more TCI states that are a subset of the set of TCI states corresponding to the set of CSI-RS resources, and wherein the one or more TCI states indicate one or more quasi co-location parameters to be used for one or more communications subsequent to the one or more CSI-RSs.

Aspect 60: The method of Aspect 59, wherein the one or more communications are one or more downlink communications, and wherein the one or more quasi co-location parameters are one or more TCI states corresponding to the one or more downlink communications.

Aspect 61: The method of Aspect 60, wherein the one or more TCI states corresponding to the one or more downlink communications are the same as the one or more TCI states associated with the one or more CSI-RSs.

Aspect 62: The method of Aspect 59, wherein the one or more communications are one or more uplink communications, and wherein the one or more quasi co-location parameters are one or more spatial relations corresponding to the one or more uplink communications.

Aspect 63: The method of Aspect 62, wherein the one or more spatial relations corresponding to the one or more uplink communications are associated with a same spatial domain transmission filter or precoder as the one or more TCI states associated with the one or more CSI-RSs.

Aspect 64: The method of any of Aspects 59-63, wherein the one or more communications are associated with a time window that is based at least in part on a time domain resource in which the one or more CSI-RSs are received.

Aspect 65: The method of Aspect 64, wherein the time window is defined by a number of time domain resources or a number of communications.

Aspect 66: The method of any of Aspects 64-65, wherein the time window is signaled to the UE in at least one of the configuration, downlink control information, a medium access control (MAC) control element, or a combination thereof.

Aspect 67: The method of any of Aspects 64-65, wherein the time window is indicated to the UE based at least in part on the one or more CSI-RS resources in which the one or more CSI-RSs are received.

Aspect 68: The method of any of Aspects 59-67, wherein the one or more quasi co-location parameters are applicable to one or more specific types of messages, one or more specific channels, one or more message configurations, or a combination thereof.

Aspect 69: The method of any of Aspects 59-67, wherein the one or more quasi co-location parameters are applicable to all types of messages, all channels, all message configurations, or a combination thereof.

Aspect 70: The method of any of Aspects 59-69, wherein the one or more quasi co-location parameters are applicable to a set of communications that occur at least a threshold amount of time after reception of the one or more CSI-RSs.

Aspect 71: The method of Aspect 70, wherein the threshold amount of time is based at least in part on a capability of the UE.

Aspect 72: The method of any of Aspects 59-70, wherein the one or more quasi co-location parameters are applicable to a first set of communications that occur at least a threshold amount of time after reception of the one or more CSI-RSs if the one or more quasi co-location parameters have changed in comparison to another one or more quasi co-location parameters used for a communication that occurs prior to reception of the one or more CSI-RSs, and wherein the other one or more quasi co-location parameters are applicable to a second set of communications that occur less than the threshold amount of time after reception of the one or more CSI-RSs if the one or more quasi co-location parameters have changed in comparison to the other one or more quasi co-location parameters.

Aspect 73: The method of any of Aspects 59-72, wherein the one or more communications include multiple communications that use multiple TCI states, wherein at least one TCI state of the multiple TCI states is indicated based at least in part on the one or more TCI states associated with the one or more CSI-RSs.

Aspect 74: The method of Aspect 73, wherein at least one other TCI state, of the multiple TCI states, is indicated based at least in part on: the one or more TCI states associated with the one or more CSI-RSs, the configuration or another signaling message, a rule associated with the at least one TCI state, a rule associated with an order in which the one or more CSI-RSs are received, or a combination thereof.

Aspect 75: The method of any of Aspects 59-72, wherein the one or more CSI-RSs consist of only a single CSI-RS, wherein the one or more CSI-RS resources consist of only a single CSI-RS resource included in the set of CSI-RS resources, and wherein the one or more TCI states consist of only a single TCI state associated with the single CSI-RS.

Aspect 76: The method of any of Aspects 59-72, wherein the one or more CSI-RSs consist of only a single CSI-RS, associated with only a single TCI state, that is repeated in multiple CSI-RS resources of the one or more CSI-RS resources.

Aspect 77: An apparatus for wireless communication at a device, comprising a processor; memory coupled with the processor; and instructions stored in the memory and executable by the processor to cause the apparatus to perform the method of one or more of Aspects 1-20.

Aspect 78: An apparatus for wireless communication at a device, comprising a processor; memory coupled with the processor; and instructions stored in the memory and executable by the processor to cause the apparatus to perform the method of one or more of Aspects 21-40.

Aspect 79: An apparatus for wireless communication at a device, comprising a processor; memory coupled with the processor; and instructions stored in the memory and executable by the processor to cause the apparatus to perform the method of one or more of Aspects 41-58.

Aspect 80: An apparatus for wireless communication at a device, comprising a processor; memory coupled with the processor; and instructions stored in the memory and executable by the processor to cause the apparatus to perform the method of one or more of Aspects 59-76.

Aspect 81: A device for wireless communication, comprising a memory and one or more processors coupled to the memory, the one or more processors configured to perform the method of one or more of Aspects 1-20.

Aspect 82: A device for wireless communication, comprising a memory and one or more processors coupled to the memory, the one or more processors configured to perform the method of one or more of Aspects 21-40.

Aspect 83: A device for wireless communication, comprising a memory and one or more processors coupled to the memory, the one or more processors configured to perform the method of one or more of Aspects 41-58.

Aspect 84: A device for wireless communication, comprising a memory and one or more processors coupled to the memory, the one or more processors configured to perform the method of one or more of Aspects 59-76.

Aspect 85: An apparatus for wireless communication, comprising at least one means for performing the method of one or more of Aspects 1-20.

Aspect 86: An apparatus for wireless communication, comprising at least one means for performing the method of one or more of Aspects 21-40.

Aspect 87: An apparatus for wireless communication, comprising at least one means for performing the method of one or more of Aspects 41-58.

Aspect 88: An apparatus for wireless communication, comprising at least one means for performing the method of one or more of Aspects 59-76.

Aspect 89: A non-transitory computer-readable medium storing code for wireless communication, the code comprising instructions executable by a processor to perform the method of one or more of Aspects 1-20.

Aspect 90: A non-transitory computer-readable medium storing code for wireless communication, the code comprising instructions executable by a processor to perform the method of one or more of Aspects 21-40.

Aspect 91: A non-transitory computer-readable medium storing code for wireless communication, the code comprising instructions executable by a processor to perform the method of one or more of Aspects 41-58.

Aspect 92: A non-transitory computer-readable medium storing code for wireless communication, the code comprising instructions executable by a processor to perform the method of one or more of Aspects 59-76.

Aspect 93: A non-transitory computer-readable medium storing a set of instructions for wireless communication, the set of instructions comprising one or more instructions that, when executed by one or more processors of a device, cause the device to perform the method of one or more of Aspects 1-20.

Aspect 94: A non-transitory computer-readable medium storing a set of instructions for wireless communication, the set of instructions comprising one or more instructions that, when executed by one or more processors of a device, cause the device to perform the method of one or more of Aspects 21-40.

Aspect 95: A non-transitory computer-readable medium storing a set of instructions for wireless communication, the set of instructions comprising one or more instructions that, when executed by one or more processors of a device, cause the device to perform the method of one or more of Aspects 41-58.

Aspect 96: A non-transitory computer-readable medium storing a set of instructions for wireless communication, the set of instructions comprising one or more instructions that, when executed by one or more processors of a device, cause the device to perform the method of one or more of Aspects 59-76.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
receiving a configuration that indicates a channel state information reference signal (CSI-RS) resource set, wherein a first set of parameters of the CSI-RS resource set depends on a second set of parameters of at least one of a message that triggers CSI-RS monitoring for the CSI-RS resource set, a physical channel associated with the CSI-RS monitoring, or an uplink reference signal associated with the CSI-RS monitoring; and
monitoring for one or more CSI-RSs, included in the CSI-RS resource set, based at least in part on the first set of parameters.

2. The method of claim 1, wherein the CSI-RS monitoring is aperiodically triggered by a medium access control (MAC) control element or aperiodically triggered by downlink control information that includes an uplink grant or a downlink grant associated with the physical channel or the uplink reference signal.

3. The method of claim 1, wherein the CSI-RS monitoring is configured or triggered for semi-persistent monitoring, or the CSI-RS monitoring is periodic CSI-RS monitoring that is configured in the configuration.

4. The method of claim 1, wherein a linkage between the first set of parameters and the second set of parameters is indicated in at least one of the configuration or the message that triggers the CSI-RS monitoring.

5. The method of claim 1, wherein the first set of parameters includes a bandwidth for the CSI-RS monitoring, and wherein the bandwidth for the CSI-RS monitoring is the same as or is a function of a bandwidth for the message that triggers CSI-RS monitoring for the CSI-RS resource set, the physical channel associated with the CSI-RS monitoring, or the uplink reference signal associated with the CSI-RS monitoring.

6. The method of claim 1, wherein the first set of parameters includes a timing offset for the CSI-RS monitoring, and wherein the timing offset for the CSI-RS monitoring is based at least in part on a timing of the message that triggers CSI-RS monitoring for the CSI-RS resource set, the physical channel associated with the CSI-RS monitoring, or the uplink reference signal associated with the CSI-RS monitoring.

7. The method of claim 1, wherein the first set of parameters includes a quasi co-location relationship for the CSI-RS monitoring, and wherein the quasi co-location relationship for the CSI-RS monitoring is based at least in part on a quasi co-location relationship of the message that triggers CSI-RS monitoring for the CSI-RS resource set, the physical channel associated with the CSI-RS monitoring, or the uplink reference signal associated with the CSI-RS monitoring.

8. The method of claim 1, wherein a timing between the one or more CSI-RSs and at least one of the uplink reference signal or a communication on the physical channel satisfies a switching delay threshold, wherein the switching delay threshold is at least one of based at least in part on a capability of the UE or indicated in at least one of the configuration or the message that triggers CSI-RS monitoring.

9. A method of wireless communication performed by a base station, comprising:
transmitting, to a user equipment (UE), a configuration that indicates a channel state information reference signal (CSI-RS) resource set, wherein a first set of parameters of the CSI-RS resource set depends on a second set of parameters of at least one of a message that triggers CSI-RS monitoring for the CSI-RS resource set, a physical channel associated with the CSI-RS monitoring, or an uplink reference signal associated with the CSI-RS monitoring; and
transmitting one or more CSI-RSs, included in the CSI-RS resource set, based at least in part on the first set of parameters.

10. The method of claim 9, wherein the first set of parameters includes a bandwidth for the CSI-RS monitoring, and wherein the bandwidth for the CSI-RS monitoring is the same as or is a function of a bandwidth for the message that triggers CSI-RS monitoring for the CSI-RS resource set, the physical channel associated with the CSI-RS monitoring, or the uplink reference signal associated with the CSI-RS monitoring.

11. The method of claim 9, wherein the first set of parameters includes a timing offset for the CSI-RS monitoring, and wherein the timing offset for the CSI-RS monitoring is based at least in part on a timing of the message that triggers CSI-RS monitoring for the CSI-RS resource set, the physical channel associated with the CSI-RS monitoring, or the uplink reference signal associated with the CSI-RS monitoring.

12. The method of claim 9, wherein the first set of parameters includes a quasi co-location relationship for the CSI-RS monitoring, and wherein the quasi co-location relationship for the CSI-RS monitoring is based at least in part on a quasi co-location relationship of the message that triggers CSI-RS monitoring for the CSI-RS resource set, the physical channel associated with the CSI-RS monitoring, or the uplink reference signal associated with the CSI-RS monitoring.

13. A user equipment (UE) for wireless communication, comprising:
a memory; and
one or more processors operatively coupled to the memory, the memory and the one or more processors configured to:
receive a configuration that indicates a channel state information reference signal (CSI-RS) resource set, wherein a first set of parameters of the CSI-RS resource set depends on a second set of parameters of at least one of a message that triggers CSI-RS monitoring for the CSI-RS resource set, a physical channel associated with the CSI-RS monitoring, or an uplink reference signal associated with the CSI-RS monitoring; and
monitor for one or more CSI-RSs, included in the CSI-RS resource set,
based at least in part on the first set of parameters.

14. The UE of claim 13, wherein the second set of parameters is for the message that triggers the CSI-RS monitoring, and wherein the message includes at least one of downlink control information, a medium access control (MAC) control element, or a combination thereof.

15. The UE of claim 13, wherein the second set of parameters is for the physical channel associated with the CSI-RS monitoring, wherein the physical channel includes at least one of a physical downlink shared channel, a physical downlink control channel, a physical uplink shared channel, a physical uplink control channel, or a combination thereof.

16. The UE of claim 13, wherein the second set of parameters is for the uplink reference signal associated with the CSI-RS monitoring, wherein the uplink reference signal is a sounding reference signal.

17. The UE of claim 13, wherein the CSI-RS monitoring is aperiodically triggered by a medium access control (MAC) control element or aperiodically triggered by downlink control information that includes an uplink grant or a downlink grant associated with the physical channel or the uplink reference signal.

18. The UE of claim 13, wherein the CSI-RS monitoring is configured or triggered for semi-persistent monitoring, or the CSI-RS monitoring is periodic CSI-RS monitoring that is configured in the configuration.

19. The UE of claim 13, wherein a linkage between the first set of parameters and the second set of parameters is indicated in at least one of the configuration or the message that triggers the CSI-RS monitoring.

20. The UE of claim 13, wherein the first set of parameters includes a bandwidth for the CSI-RS monitoring, and wherein the bandwidth for the CSI-RS monitoring is the same as or is a function of a bandwidth for the message that triggers CSI-RS monitoring for the CSI-RS resource set, the physical channel associated with the CSI-RS monitoring, or the uplink reference signal associated with the CSI-RS monitoring.

21. The UE of claim 13, wherein the first set of parameters includes a timing offset for the CSI-RS monitoring, and wherein the timing offset for the CSI-RS monitoring is based at least in part on a timing of the message that triggers CSI-RS monitoring for the CSI-RS resource set, the physical channel associated with the CSI-RS monitoring, or the uplink reference signal associated with the CSI-RS monitoring.

22. The UE of claim 13, wherein the first set of parameters includes a quasi co-location relationship for the CSI-RS monitoring, and wherein the quasi co-location relationship for the CSI-RS monitoring is based at least in part on a quasi co-location relationship of the message that triggers CSI-RS monitoring for the CSI-RS resource set, the physical channel associated with the CSI-RS monitoring, or the uplink reference signal associated with the CSI-RS monitoring.

23. The UE of claim 13, wherein a timing between the one or more CSI-RSs and at least one of the uplink reference signal or a communication on the physical channel satisfies a switching delay threshold, wherein the switching delay threshold is at least one of based at least in part on a capability of the UE or indicated in at least one of the configuration or the message that triggers CSI-RS monitoring.

24. A base station for wireless communication, comprising:
a memory; and
one or more processors operatively coupled to the memory, the memory and the one or more processors configured to:
transmit, to a user equipment (UE), a configuration that indicates a channel state information reference signal (CSI-RS) resource set, wherein a first set of parameters of the CSI-RS resource set depends on a second set of parameters of at least one of a message that triggers CSI-RS monitoring for the CSI-RS resource set, a physical channel associated with the CSI-RS monitoring, or an uplink reference signal associated with the CSI-RS monitoring; and
transmit one or more CSI-RSs, included in the CSI-RS resource set,
based at least in part on the first set of parameters.

25. The base station of claim 24, wherein the CSI-RS monitoring is aperiodically triggered by a medium access control (MAC) control element or aperiodically triggered by downlink control information that includes an uplink grant or a downlink grant associated with the physical channel or the uplink reference signal.

26. The base station of claim 24, wherein the CSI-RS monitoring is configured or triggered for semi-persistent monitoring, or the CSI-RS monitoring is periodic CSI-RS monitoring that is configured in the configuration.

27. The base station of claim 24, wherein a linkage between the first set of parameters and the second set of parameters is indicated in at least one of the configuration or the message that triggers the CSI-RS monitoring.

28. The base station of claim 24, wherein the first set of parameters includes a bandwidth for the CSI-RS monitoring, and wherein the bandwidth for the CSI-RS monitoring is the same as or is a function of a bandwidth for the message that triggers CSI-RS monitoring for the CSI-RS resource set, the physical channel associated with the CSI-RS monitoring, or the uplink reference signal associated with the CSI-RS monitoring.

29. The base station of claim 24, wherein the first set of parameters includes a timing offset for the CSI-RS monitoring, and wherein the timing offset for the CSI-RS monitoring is based at least in part on a timing of the message that triggers CSI-RS monitoring for the CSI-RS resource set, the physical channel associated with the CSI-RS monitoring, or the uplink reference signal associated with the CSI-RS monitoring.

30. The base station of claim 24, wherein the first set of parameters includes a quasi co-location relationship for the CSI-RS monitoring, and wherein the quasi co-location relationship for the CSI-RS monitoring is based at least in part on a quasi co-location relationship of the message that triggers CSI-RS monitoring for the CSI-RS resource set, the physical channel associated with the CSI-RS monitoring, or the uplink reference signal associated with the CSI-RS monitoring.
